(19) United States
(12) Patent Application Publication
(10) Pub. No.: US 2017/0083832 A1
(43) Pub. Date: Mar. 23, 2017

(54) SYSTEMS AND METHODS FOR PLANNING AND TRACKING TRAVEL

(71) Applicant: Matthew David Williams, Danville, CA (US)

(72) Inventor: Matthew David Williams, Danville, CA (US)

(21) Appl. No.: 15/268,372

(22) Filed: Sep. 16, 2016

Related U.S. Application Data
(60) Provisional application No. 62/220,203, filed on Sep. 17, 2015.

(51) Int. Cl. G06Q 10/02; G06Q 40/02

(52) U.S. Cl. CPC G06Q 10/02; G06Q 40/02; G06Q 50/14

(57) ABSTRACT

A personalized travel assistant aids travelers in the planning, booking and tracking of a trip, taking into consideration personal preferences. The assistant can connect multiple users of the platform to sharing in trips or portions of a trip, and aiding them in sharing information about their trip with authorized persons. The assistant can recommend waypoints, accommodations and activities based on the traveler preferences. The assistant can book and reserve accommodations, activities and travel throughout the trip, and aid the user in connecting with other users. Finally, the system can track the user along the trip as the user completes the trip, and if instructed, the system can share information regarding the trip with authorized persons.

### CROSS REFERENCE TO RELATED APPLICATIONS

This non-provisional application claims the benefit of provisional application No. 62/220,203, filed Sep. 17, 2015, which application is incorporated herein in its entirety by this reference.

### BACKGROUND

The present invention relates to systems and methods for aiding in the planning, organizing, booking and tracking of a trip, especially that of the backpacking kind. In particular, the systems and methods present a user with the capability of researching, planning, booking and tracking a trip all in one application.

Trip planning often involves an individual (user) researching the planned route of the trip and booking all of the transportation, lodging, tours and attractions along the planned route. Very often the transportation, lodging, tours and attractions cannot be researched or booked on the same website or through the same travel service. The present invention can bring all of these aspects of trip planning into one easy to use and centralized service.

In addition to aiding users in planning and booking a trip, the platform can also track the user(s) throughout the trek. The platform can also report information to authorized individuals. This functionality is very appropriate for a service that targets backpackers. Backpacking sometimes takes a traveler off of the designated route, and tracking functionality is necessary for safety and peace of mind. Currently, tracking software is not widely available unless consumers invest in dedicated GPS systems or GPS-like applications.

Another function the application performs is the matching (e.g., pairing) of users with one another based on similar itineraries. This will allow the users to facilitate different events, for example ride shares, meet ups, group tours, and accommodation sharing.

It is therefore apparent that an urgent need exists for a system that brings many features together that are tailored to help travelers, especially backpackers, to have a fun and safe traveling experience Such a system encompasses planning, booking and tracking into one organized and easy to use platform. The TrekTracks platform can fulfill this void of products currently available to consumers.

### SUMMARY

To achieve the foregoing and in accordance with the present invention, systems and methods for the personalized planning, organizing, booking and tracking of trips provided. In particular the systems and methods for recommending portions or all of a travel itinerary based on preferences set forth by a traveler, and the booking and tracking of the resulting itinerary.

In one embodiment, a computerized, customizable personal planner system is configured to receive a recommendation request for part or all of a travel plan from a traveler and provide at least one choice in response to the received recommendation. The provided choice includes one of transportation, food and lodging associated with the destinations of the travel plan. The choice also includes supplemental information and options for the destinations of the travel plan. The choice is then implemented into the travel plan.

The planner system is configured to provide at least one choice for each of the legs of the travel plan. The choice could be lodging, food or attractions at the starting and ending points of the leg, and the choice could include transportation between the starting and ending points of the leg.

The planner system is configured to provide at least one new travel option for each leg of the travel plan in response receiving a change in preferences from the traveler. This change could be a change in destination, budget or the time the traveler wants to spend on a particular leg of the trip. The system is configured to re-suggest travel options upon receiving a preference change.

The planner system is configured to provide substantially real-time trek progress to the traveler as the traveler begins and completes each leg of the trip. The system is also configured to provide substantially real-time trek progress to at least one previously authorized recipient.

The planner system is configured to facilitate the pairing of the traveler with at least one potential travel companion for part or all of the travelers' trips. The travel companions will have substantially similar itineraries to be considered as a traveling companion. The system is configured to provide the traveler with part or all of at least one potential travel companion's profile.

The planner system is configured to debit a traveler's account upon the traveler completing the planning and booking process. The system is also configured to credit a second traveler's account upon the completion of the planning and booking process.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 depicts an exemplary hardware configuration for implementing the TrekTracks platform in accordance with one embodiment of the present invention;

FIG. 2 is a flow chart of a possible way the TrekTracks platform of FIG. 1 can take data input from the user, recommend travel choices and augment those recommendations to form a trek, culminating with payment by the user for the trek that was just formed;

FIG. 3A is a flow chart of a possible way the TrekTracks platform can receive input data from users regarding the preferences for a trek;

FIG. 3B is a flow chart of a possible way the TrekTracks platform can suggest and then re-suggest travel choices based on user inputs;

FIG. 3C is a flow chart of a possible way the TrekTracks platform can recommend the sharing options for a user's trek;

FIG. 3D is a flow chart of a possible way the TrekTracks platform can receive a users preference to either share or not share trek information and with whom it should be shared;

FIG. 3E is a flow chart of a possible way the TrekTracks platform can access and credit or debit a user's loyalty points, TrekMiles, to pay for part/all of the trek or upgrade selections of the trek;

FIGS. 4A-4C are possible renders of the dashboard for the TrekTracks platform;

FIGS. 5A and 5B are possible renders of Step 1 in the TrekPlanner process—selecting a trek/creating a new trek, travel dates and overall budget;

FIG. 6 is a possible render of Step 2 in the TrekPlanner process—country, weight of time and country budget;

FIG. 7A is a possible render of Step 3 in the TrekPlanner process—city, weight of time and city budget data by country;

FIG. 7B is a possible render of Step 4 in the TrekPlanner process—pull down menus regarding lodging, attractions and tour information;

FIG. 7C is a possible render of Step 4A in the TrekPlanner process—selecting lodging accommodations by city;

FIG. 7D is a possible render of Step 4A in the TrekPlanner process—the user uploading a hotel's information manually into the itinerary;

FIG. 7E is a possible render of Step 4B in the TrekPlanner process—selecting attractions by city;

FIG. 7F is a possible render of Step 4C in the TrekPlanner process—selecting tours by city;

FIGS. 8A-8D are possible renders of an overview screen, which can contain all of the data collected or suggested in the above TrekPlanner steps;

FIG. 9 is a possible render of the transportation selection step in the TrekPlanner—modes of transportation, by transportation leg;

There are no FIGS. 10, 11 and 12 in this application;

FIG. 13 is a possible render of a screen where a user can input data regarding TravelBuddy preferences;

FIGS. 14A-14C are possible renders of a screen where the TrekTracks platform can show a user's matches based on the TravelBuddy preferences;

FIG. 15 is a possible render of a screen where the TrekTracks platform can show two matched users' wishlists along with other information regarding the matched users;

FIG. 16 is a possible render of a screen where the TrekTracks platform can show two matched users' itineraries along with other information regarding the matched users;

FIG. 17 is a possible render of a TrekTracks user's profile;

FIGS. 18A and 18B are possible renders of a screen where the user can select preferences for ridesharing and TravelBuddies;

FIG. 19 is a possible render of a screen where the TrekTracks platform can show a user's itinerary with travel dates, matched users and information regarding ridesharing opportunities; and

FIG. 20 is a possible render of a screen where the TrekTracks platform can show a user an overview of either selected or possible TravelBuddies and/or ridesharing opportunities.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates generally to systems and methods for manipulating and utilizing data in a database or databases accessed over wide area networks (WANs) via any wide assortment of electronics network terminal devices. Specifically, the present invention is directed to novel methods and systems to aid consumer(s) (“user(s)”) in the planning, organizing, booking, and/or executing a trip, vacation and/or expedition (“trek”). Additionally, the present invention is directed to novel methods and systems to aid the user(s) in the sharing of trek information with: other users of the present invention to facilitate group or companion travel; and with friends, family and/or specified others for the purpose of sharing the progress of the trek.

Of note is that, in the remainder of the application, particular attention is placed upon visual displays. It is important to realize that the present invention may apply equally well to operation with all manner of the consumer electronic network terminal devices including, but not limited to, mobile communication devices, computers, tablet computer systems, e-reader devices, and virtually any electronic device which includes WAN access and a user interface.

The present application includes a description of an exemplary data collection, request processing and fulfillment agent system which interposes between database(s) and the user interfaces of the electronic network terminal devices in such a way as to provide aid to users in the planning, organizing, booking, executing and/or sharing a trek or information about the trek.

The described embodiments of the present invention enables a user to: provide specifications about a trek or treks the user would like to plan, book and/or embark on; receive suggestions regarding a trek in response to provided specifications; book or reserve portions or elements of a trek; share information about a trek with specified others and other users of the present invention; arrange group travel between other users of the present invention; track the completion of the trek.

### I. TrekTracks Server and Hardware

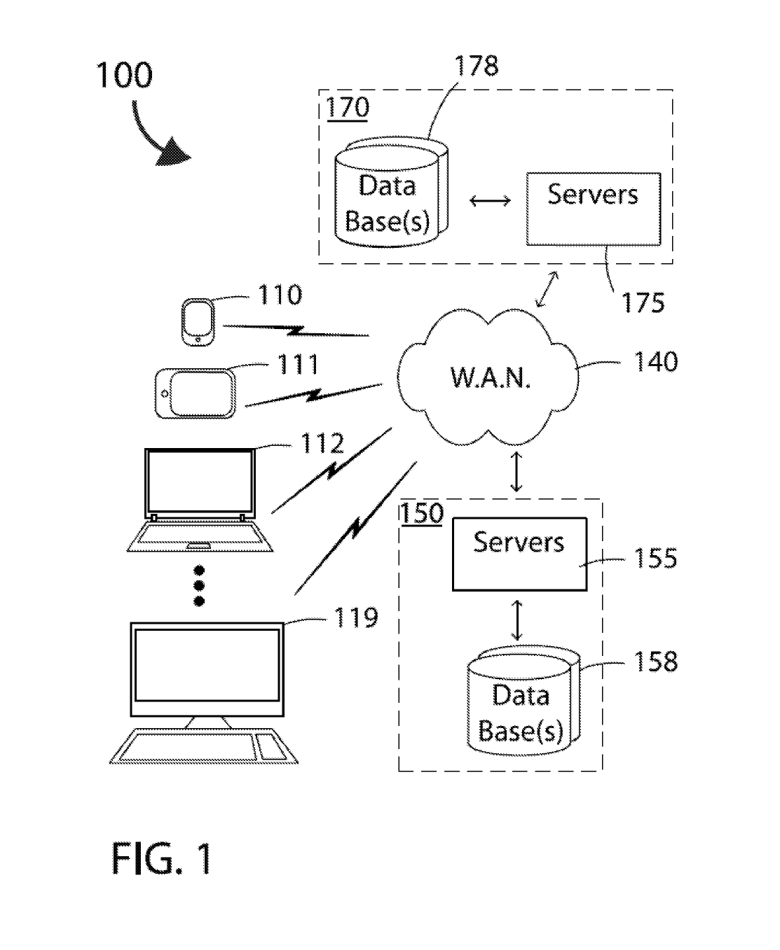

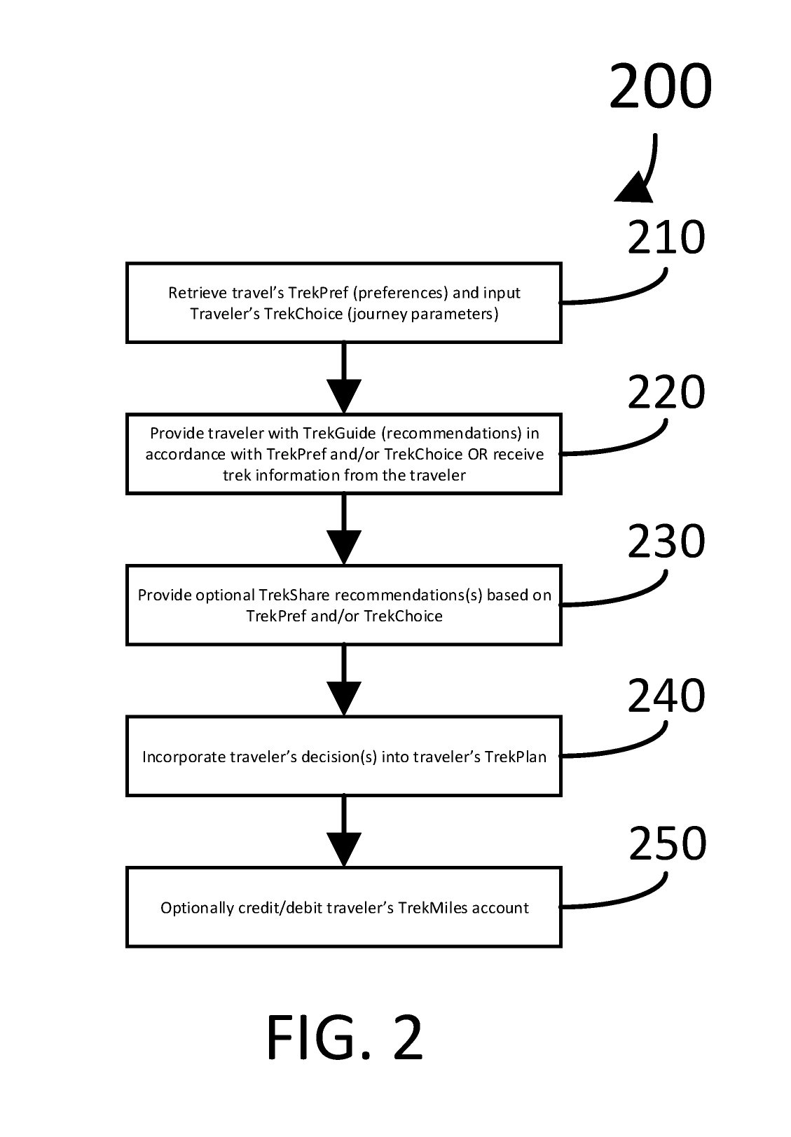

The structural block diagram FIG. 1 depicts one possible embodiment of a TrekTracks platform in accordance with the present invention. The information provided by the TrekTracks platform can be provided by the TrekTracks servers 155, 175. The TrekTracks servers can retrieve information from the TrekTracks databases 158, 178. The information from the TrekTracks servers can be delivered to the user through a wide area network (W.A.N.) 140. The user can receive the information delivered by the TrekTracks platform on one or multiple electronic devices 110, 111, 112 . . . 119. The user devices choices, 110 through 119, represent the wide array of devices that can support access to the TrekTracks platform. Often these devices are mobile communications devices or computers—typically with Wi-Fi, cellular data or other wireless connections, but the devices capable of supporting the TrekTracks platform should not be limited to electronic devices in these categories.

Multiple electronic devices can be used to access the same TrekTracks account and information. The user should not be limited to using the TrekTracks application on only one device. For example, a user can start the trek planning process on a desktop computer 119, finish the trek planning process on a tablet 111 and track the trek on a mobile cellular phone 110.

It follows that with multiple devices at the user's disposal to access the TrekTracks platform, the tools used for data input can change. While using a desktop computer 119 or laptop computer 112, the user can use a computer mouse and/or keyboard to aid the user with providing information and data to the TrekTracks platform. While the user is using a tablet device 111 or mobile cellular device, the user can simply use the touch screen functionality (if applicable) to aid the user with providing information and data to the TrekTracks platform. The data input methods should not be limited to the above examples.

### II. TrekTracks Dashboard

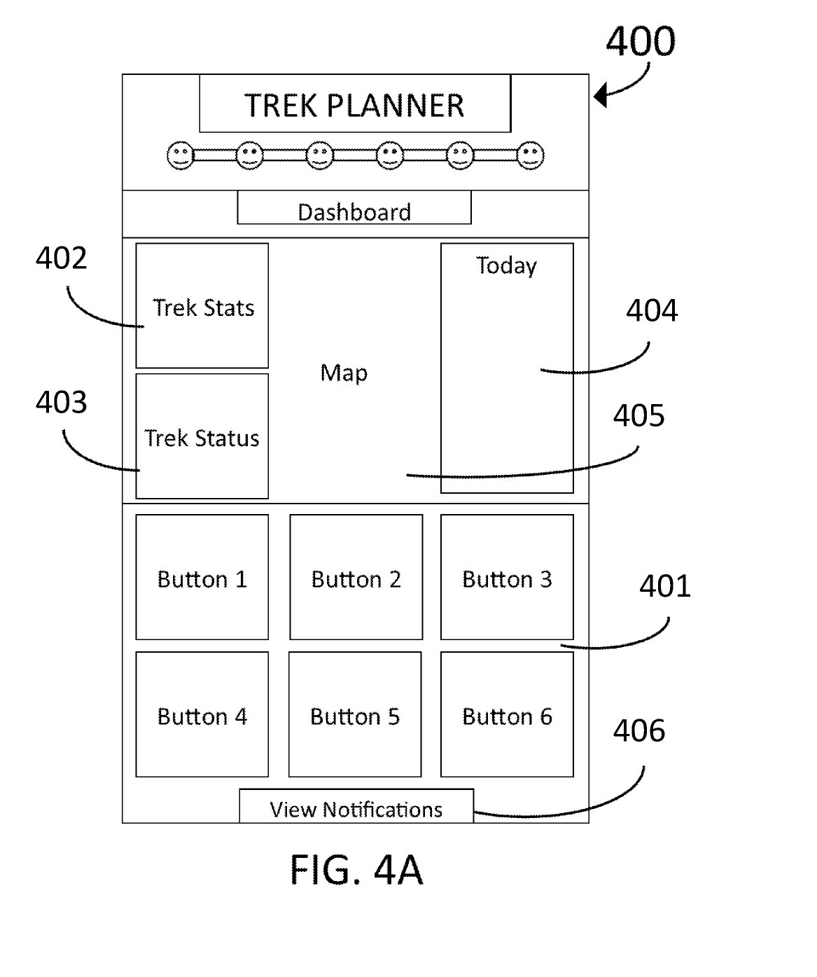

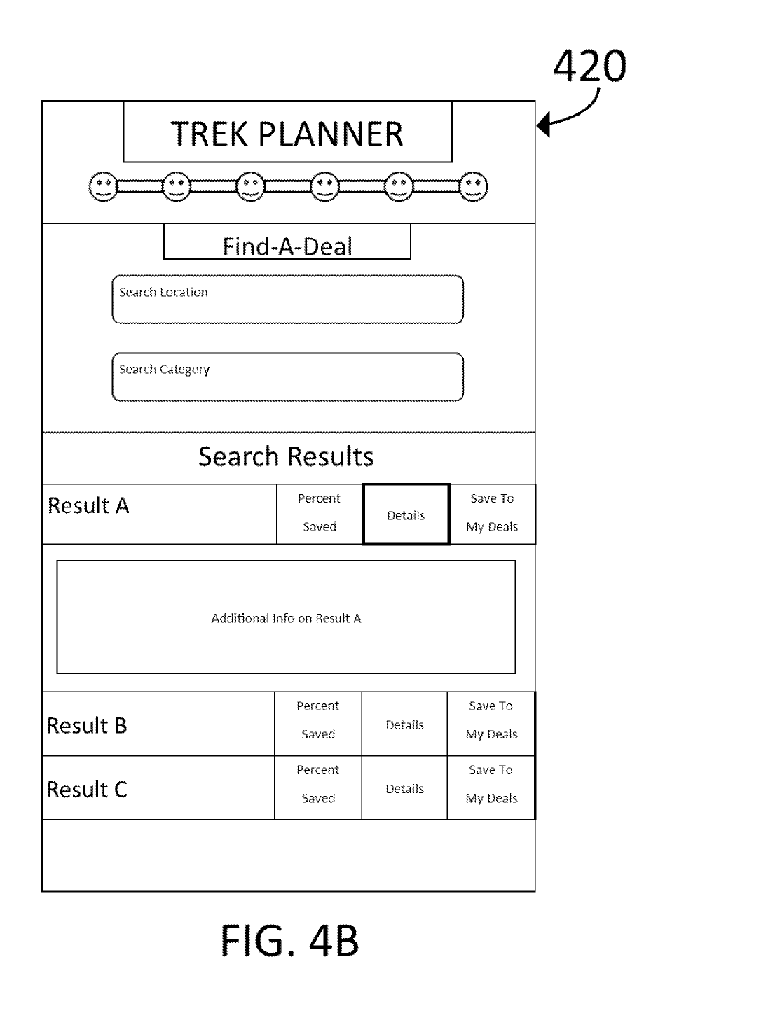

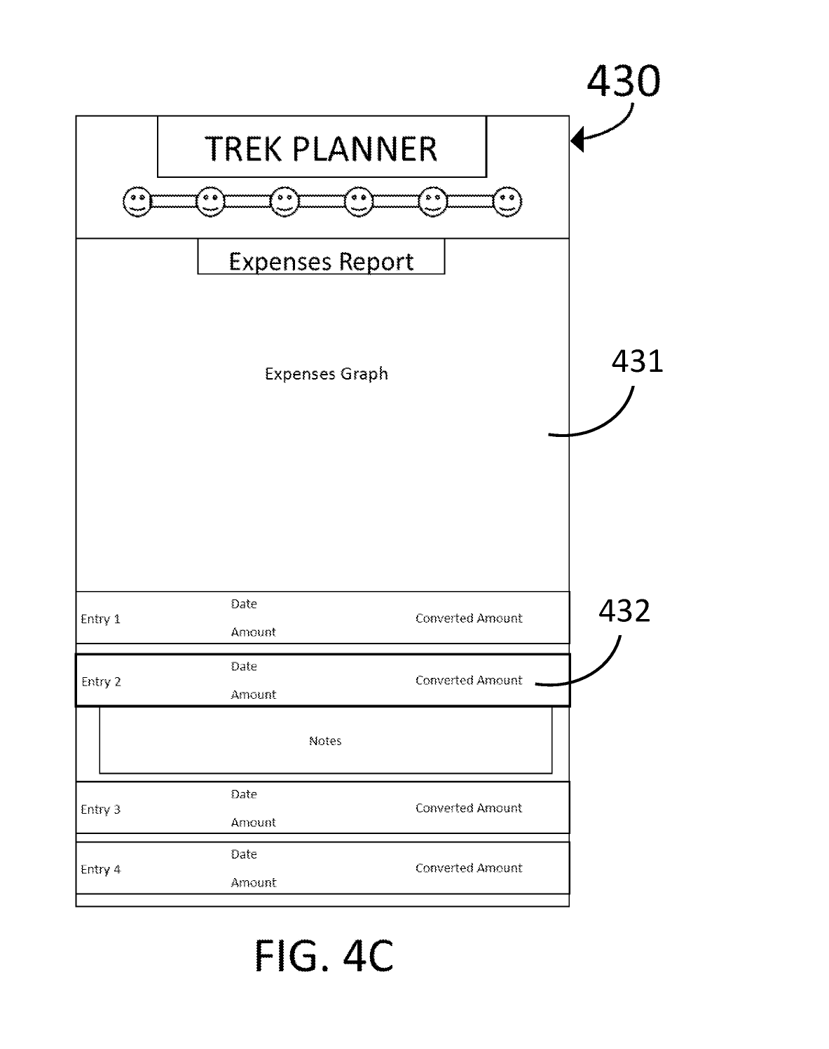

The “dashboard” FIG. 4A of the TrekTracks platform can be a central location for the platform where the user can: view information regarding to the currently selected trek; view an interactive map; view the current day's itinerary; view notifications pertaining to the current trek; navigate to other sections of the TrekTracks platform.

The dashboard can display a button console 401. This button console can have links to other sections of the TrekTracks platform. These links can include, but are not limited to, current trek itinerary, trek timeline, map, tools, TrekGuides, account information, and help.

The dashboard can display information or statistics 402 regarding the currently selected trek. This information can include, but is not limited to, cost of the trek, total days of the trek or number of countries the trek includes, weather statistics from entire trek, flight statistics from entire trek, and number of friends or connections made throughout the trek

The dashboard can display information 403 regarding the status of the currently selected trek. This information can be presented by a color code indicating the status of planning phases, including, but not limited to, planning, booking and pre-departure.

The dashboard can display information 404 regarding the current day's itinerary or tasks that need completing. This may include, but is not limited to, the daily budget, the daily weather, flight information, hotel information, local news bulletins, and links to nearby attractions.

The dashboard can display a map 405 of the current area or the area covered by the currently selected trek. The map can provide including, but not limited to, information regarding starting and ending destinations, waypoints, lodging, attractions and tour sites. The map provides a visual representation of the entire trip, with information available, for example, by tapping on waypoints.

The dashboard can display a notifications section 406. This section can display including, but not limited to, information regarding travel delays or departure times, local and destination weather and news, itinerary updates, and government issued travel warnings

### III. TrekTracks Planner

The “TrekPlanner” can be a portion of the TrekTracks platform used for selecting preferences regarding the planning of a trek. The TrekPlanner can allow for users to select from prepurchased trek templates (treks designed by TrekTracks) or create a custom trek; input data regarding the starting, ending and waypoints of the trek including, but not limited to, countries, cities, lodging, attractions and tours; connect with users to arrange for travel companions and/or ridesharing.

Upon entry of trek data by a user, the platform may provide a user with special offers or discounts 420 based on this information, which may appear as FIG. 4B. The system offers results based on factors such as location and personal interests, ensuring relevant results. The layout described in FIG. 4B is just one possible configuration, and may display any variety of information, including but not limited to the amount saved by the user, details about the business, and may provide the ability for the user to save the deal for later.

While utilizing the Trek Tracks system, a user may enter costs into the expenses report 430 described in FIG. 4C. This feature allows detailed tracking of expenditures throughout the trip to allow for more accurate and reliable budgeting. This information may be described in both a visual or text based format. An expenses graph 431 may be displayed, and an interactive button console 432 may be used to view a more detailed description of expenses.

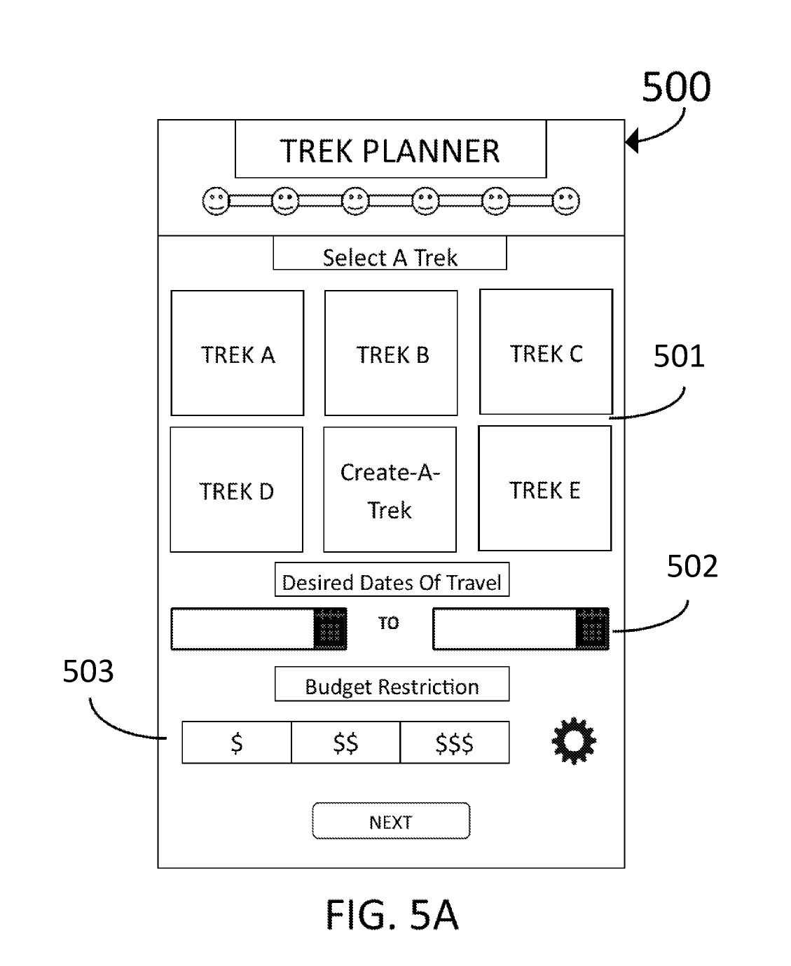

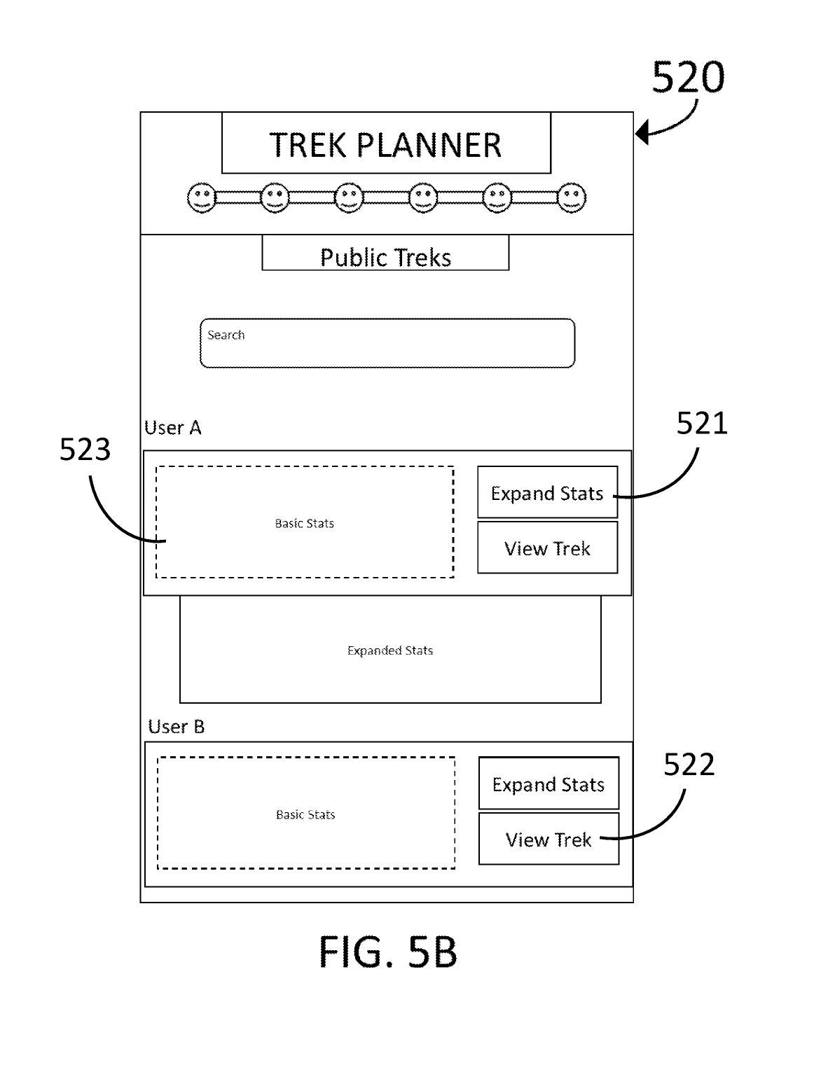

A user can enter the TrekPlanner from the dashboard 400. Step 1 FIG. 5A of the TrekPlanner can include a section 501 where the user can select an existing trek from either the crowd sourced database or their past activity, or create a custom trek. Step 1 can include a section 502 where the user can select the desired dates of travel. Step 1 can include a section 503 where the user can enter the desired budget for the trek.

FIG. 5B describes a possible rendering of the crowd sourced trek database portal. This provides the hub for users to share and find user created content. This may be configured to display various statistics 523 for the user, such as total distance, estimated costs, number of nights, and other important details. Button 521 may expand these details for more information. Button 522 may redirect the user to the trek overview page 830.

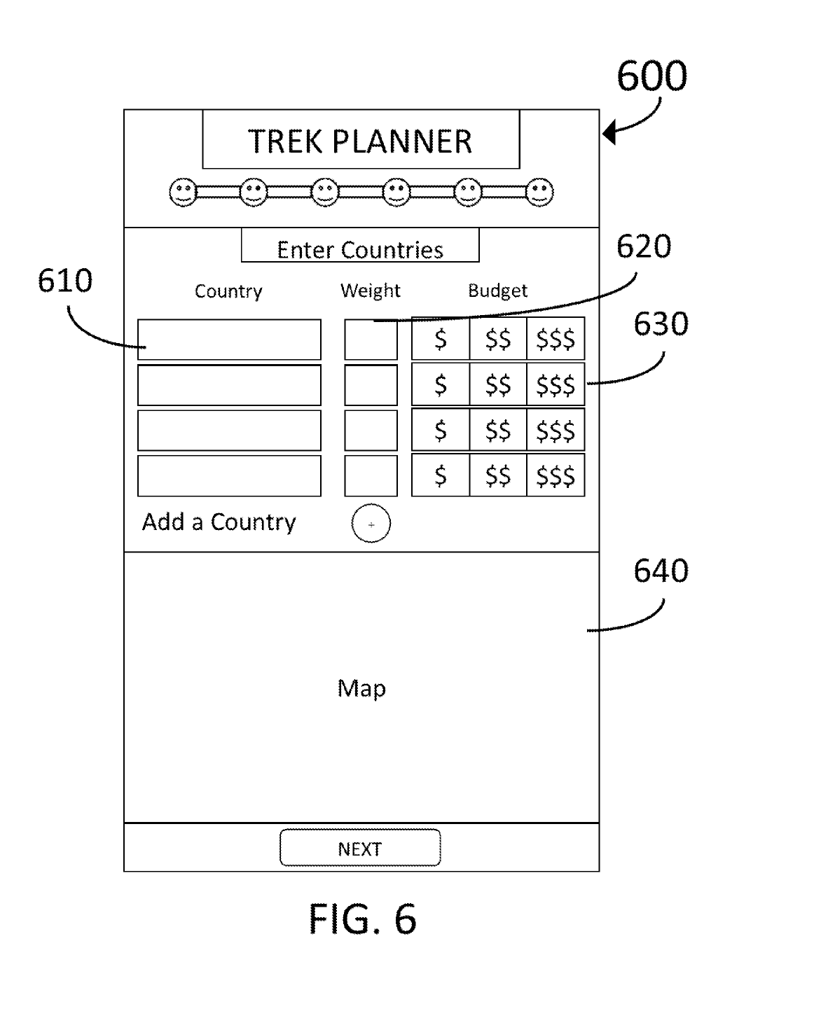

Step 2 FIG. 6 of the TrekPlanner can allow the user to input data regarding the destination country/countries. Step 2 can include a section 610 for the user to input the desired country/countries of travel. Step 2 can include a section 620 for the user to input the desired weight of time to spend in a particular country. Step 2 can include a section 630 for the user to input the desired budget for a particular country. Step 2 can include a map 640 showing the trek route as information is entered in the above sections.

The budget restrictions set in section 630 may be used to provide suggested budgets based on preferences set by the user. For example, a user may allocate 60% of the budget to Country A and 40% of the budget to Country B. The system will automatically set a daily budget suggestion for the user, which will integrate with the expenses report described in FIG. 4C.

If the trek is pre-purchased or saved from the crowd sourced database, the sections as listed above for Step 2 and displayed in FIG. 6 can be prepopulated with recommendations provided by the TrekTracks platform and other users. The user can change one or more of these pieces of information including, but not limited to, the country, budget for a particular country or weight of time spent in a particular country, and the TrekTracks platform can adjust the pre-planned trek, taking into account the user's change(s). An example includes, but is not limited to, a user changing the budget for a given destination country, and the TrekTracks platform responding by suggesting including, but not limited to, new weight of time spent in that country, different cities visited, or changing lodging, attractions or tours in that country.

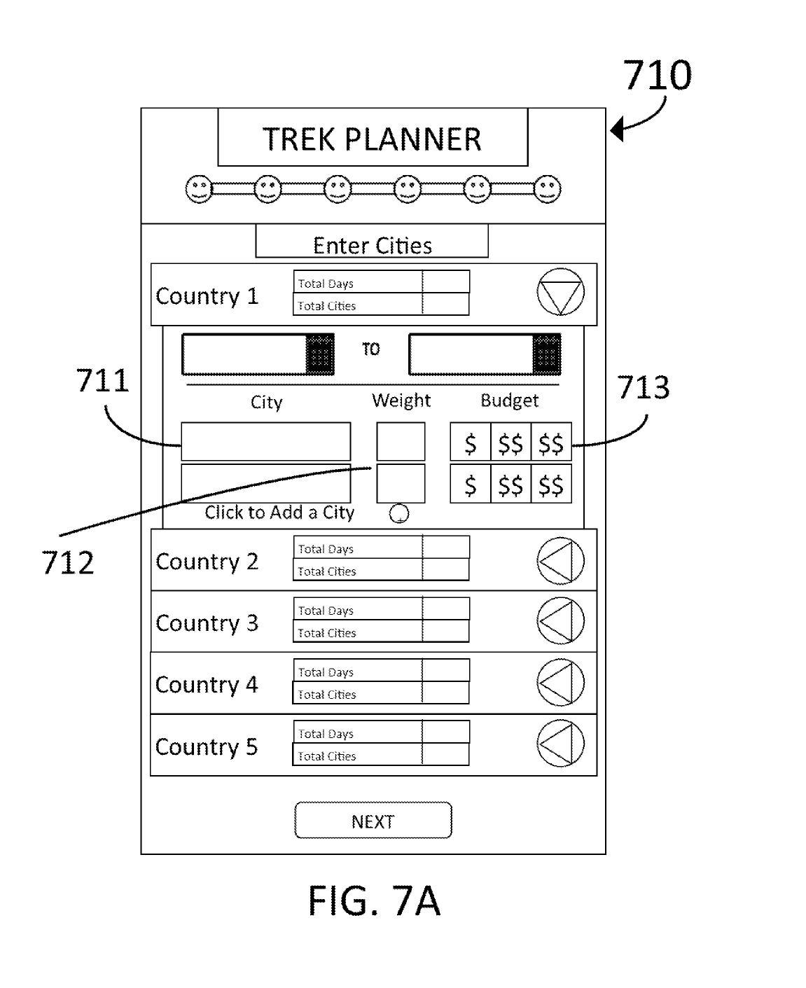

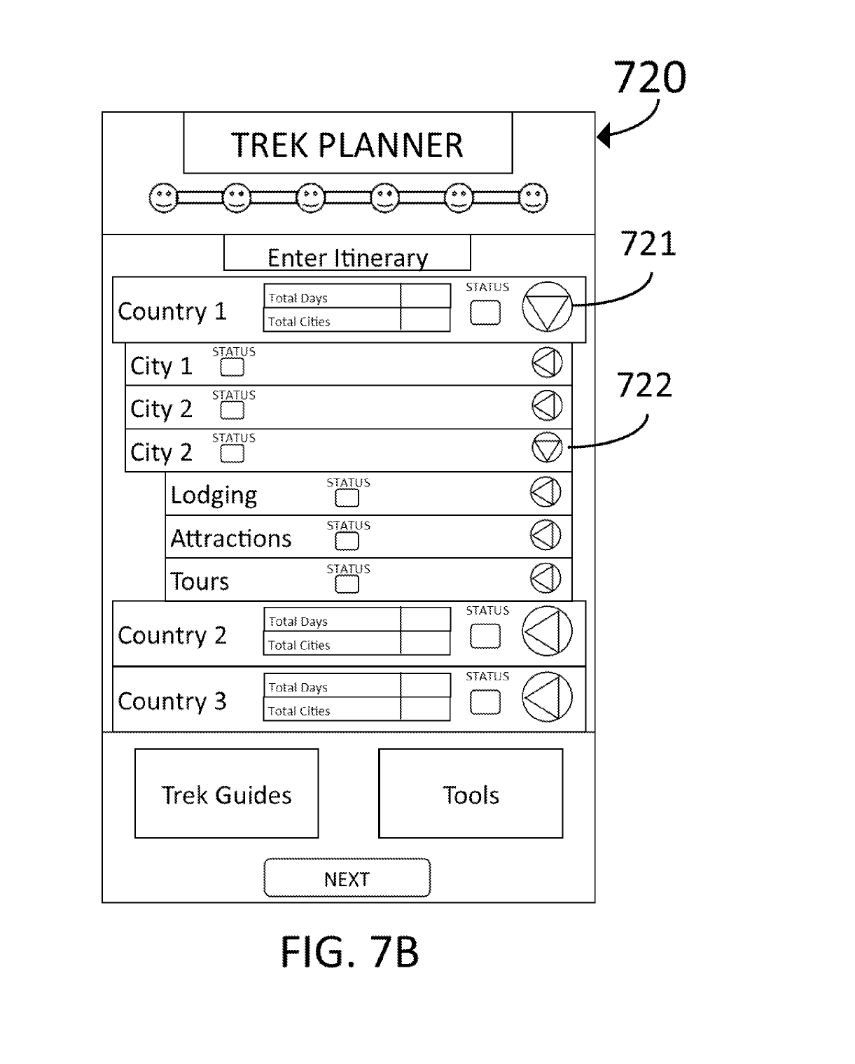

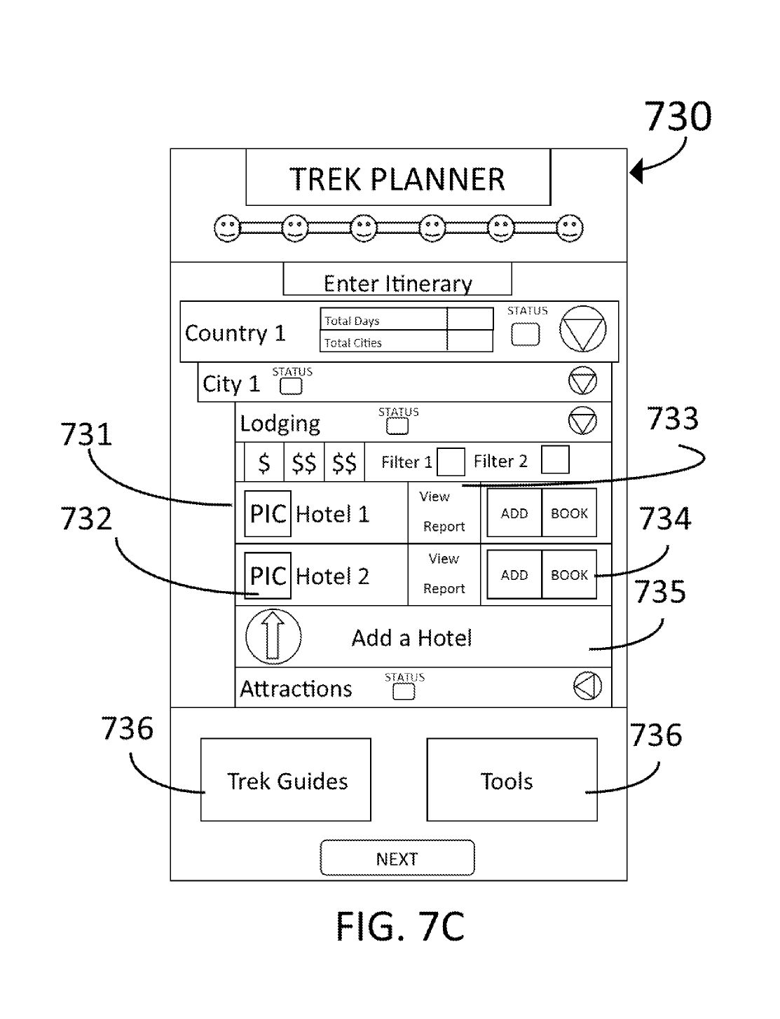

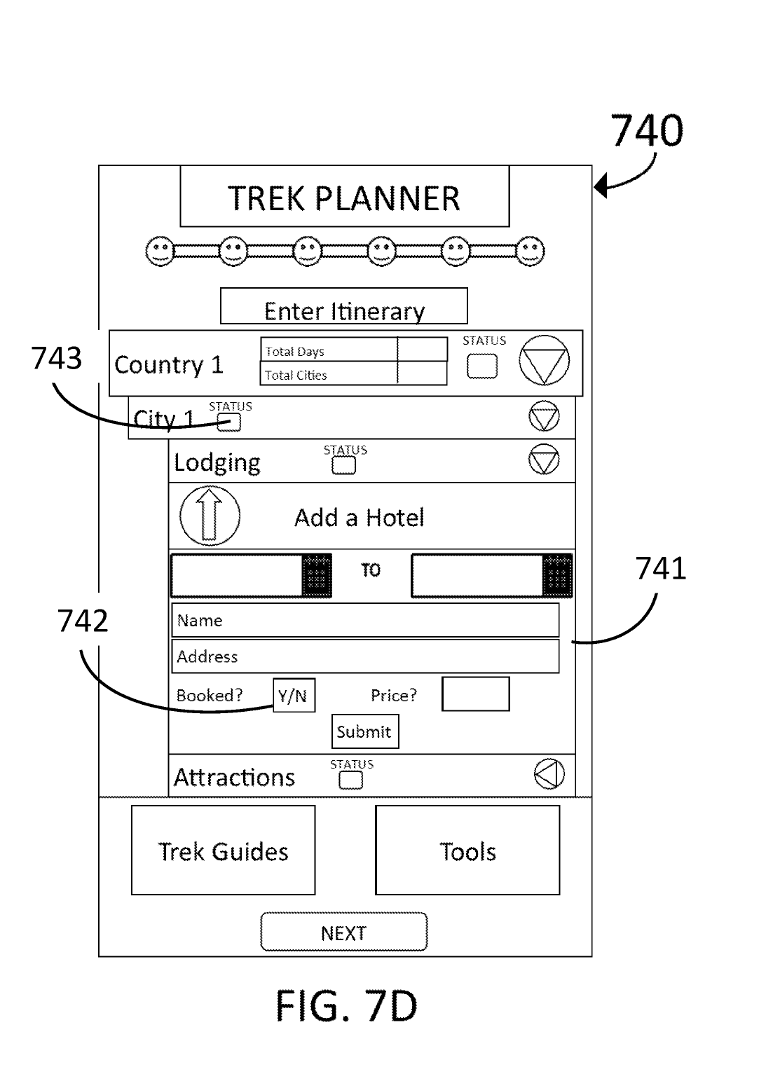

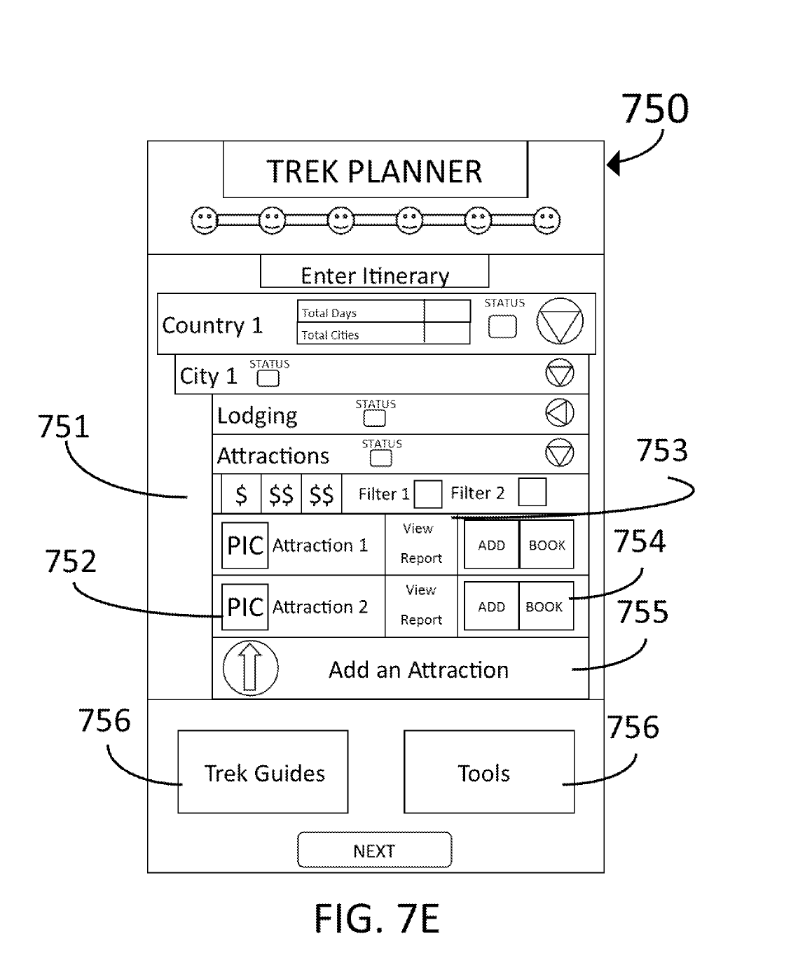

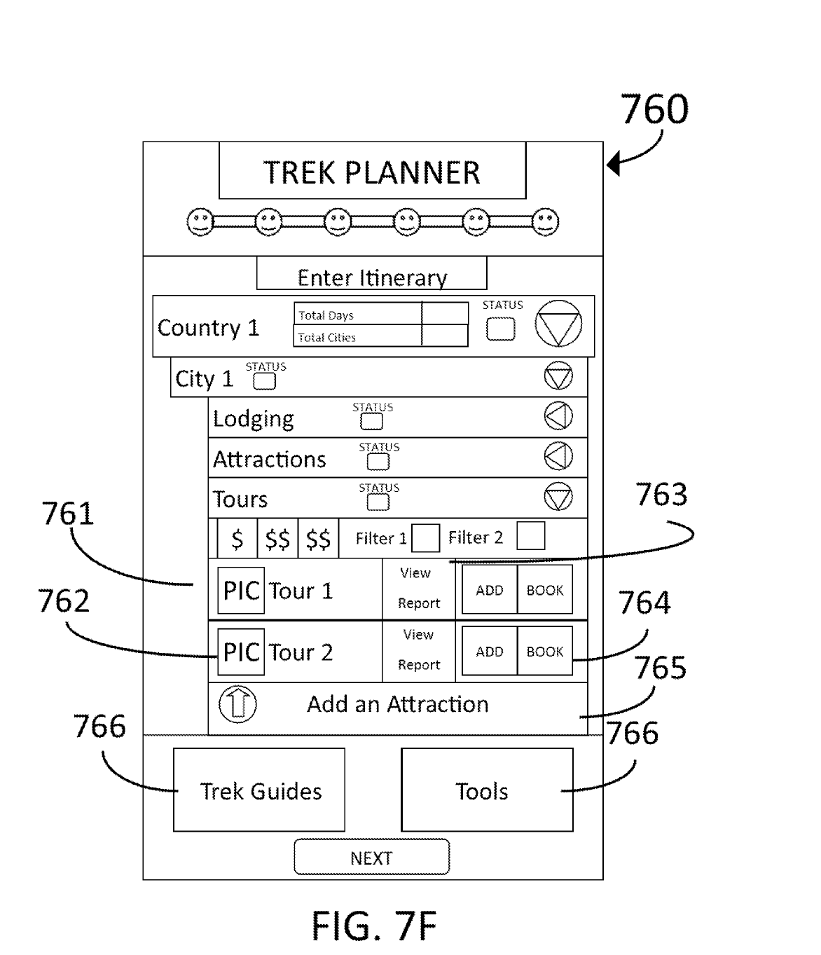

Step 3 FIG. 7A of the TrekPlanner can allow the user to input data regarding the destination city/cities. Step 3 can include a section 711 for the user to input the desired city/cities of travel. Step 3 can include a section 712 for the user to input the desired weight of time spent in a particular city. Step 3 can include a section 713 for the user to input the desired budget for particular city. Step 3 can include sections 711, 712, 713 for all of the destination countries.

If the trek is pre-purchased or saved from the crowd sourced database, the sections as listed above for Step 3 and displayed in FIG. 7A can be prepopulated with recommendations provided by the TrekTracks platform, taking into consideration the original trek preferences and any alterations the user has made to the preplanned trek in the previously mentioned data input steps. The user can change one or more of these pieces of information including, but not limited to, the city, budget for a particular city or weight of time spent in a particular city, and the TrekTracks platform can adjust the pre-planned trek, taking into account the user's change(s). An example includes, but is not limited to, a user changing the weight of time spent in a particular city, and the TrekTracks platform responding by suggesting including, but not limited to, a new budget for that city or other destinations, new weight of time spent in other destinations, or changes to lodging, attractions or tours in that or other destination cities.

Step 4 FIG. 7B can include sections for the user to input data regarding the lodging, attractions and tours for each of the destination cities. The user can use drop down menus to select the country 721 and the city 722 in that country that the user wishes to edit the information for.

Step 4A FIG. 7C can include sections and information regarding the lodging for a particular city. Step 4A can include suggestions of TrekTracks approved hotels 731. When Trek Tracks approved hotels are unavailable, the system may display content from a third party ratings service, or data from other Trek Tracks users. This section can include a picture 732 of the suggested hotel, a link to view a report about the hotel 733, and the ability to either add the hotel to the trek's itinerary or book the hotel 734 through a TrekTracks approved booking site. Step 4A can include a section 735 for the user to upload a hotel not already in the TrekTracks database. The system may integrate with any number of third party services to facilitate reviews, bookings, and recommendations.

If the trek is pre-purchased or saved from the crowd sourced database, the lodging information for each destination city can be prepopulated by the TrekTracks platform, taking into consideration the original trek preferences and any alterations the user has made to the preplanned trek in the previously mentioned data input steps. The user can change one or more of the suggested lodging options and the TrekTracks platform can respond by providing other lodging suggestions throughout the trek to stay within the preferences set by the user.

Step 4A can include a link to the TrekGuides 736. The TrekGuides can suggest information to the user to help the user complete this section of the planning process. This information may be sourced from a third party site.

FIG. 7D depicts a possible configuration of a data input screen that would allow a user to enter their booking information. This may include a console 741 for a user to enter information such as the name of the hotel, the price, and its address. Button 742 allows the user to tell the system if an actual booking has been made. Selecting this option may change status light 743 to green. If data has been input, but button 742 is not selected, status light 743 may appear as yellow. If no data is input, the status light 743 may remain red.

Step 4B FIG. 7E can include sections and information regarding the attractions for a particular city. Step 4B can include suggestions of TrekTracks approved attractions 751. This section can include a picture 752 of the suggested attraction, a link to view a report about the attraction 753, and the ability to either add the attraction to the trek's itinerary or book the attraction 754 (if necessary) through a TrekTracks approved booking site. Step 4B can include a section 755 for the user to upload an attraction not already in the TrekTracks database.

After selecting section 755, the user may be redirected to a screen similar to the one displayed in FIG. 7D, and will give the user the option to input information such as the name of the attraction, the price, and its address. The user will also be able to adjust the displayed status of the booking, as described above in FIG. 7D.

If the trek is pre-purchased, the attraction information for each destination city can be prepopulated by the TrekTracks platform, taking into consideration the original trek preferences and any alterations the user has made to the preplanned trek in the previously mentioned data input steps. The user can change one or more of the suggested attraction options and the TrekTracks platform can respond by providing other attraction suggestions throughout the trek to stay within the preferences set by the user.

Step 4B can include a link to the TrekGuides 756. The TrekGuides can suggest information to the user to help the user complete this section of the planning process.

Step 4C FIG. 7F can include sections and information regarding the tours for a particular city. Step 4C can include suggestions of TrekTracks approved tours 761. This section can include a picture 762 of the suggested tour, a link to view a report about the tour 763, and the ability to either add the tour to the trek's itinerary or book the tour 764 through a TrekTracks approved booking site. Step 4C can include a section 765 for the user to upload a tour not already in the TrekTracks database.

After selecting section 765, the user may be redirected to a screen similar to the one displayed in FIG. 7D, and will give the user the option to input information such as the name of the attraction, the price, and its address. The user will also be able to adjust the displayed status of the booking, as described above in FIG. 7D.

If the trek is pre-purchased, the tour information for each destination city can be prepopulated by the TrekTracks platform, taking into consideration the original trek preferences and any alterations the user has made to the preplanned trek in the previously mentioned data input steps. The user can change one or more of the suggested touring options and the TrekTracks platform can respond by providing other touring suggestions throughout the trek to stay within the preferences set by the user.

Step 4C can include a link to the TrekGuides 766. The TrekGuides can suggest information to the user to help the user complete this section of the planning process.

An example of how a user can add custom information is shown in FIG. 7D. This is an example of adding a hotel not already in the TrekTracks database 740, Step 4A, but should be considered for lodging, attractions, tours and any other data input that follows the example form. The user can input data regarding the information of the hotel including, but not limited to, dates of stay, name, address, confirmation number and price. The user can be given the option to indicate if this hotel has already been booked.

The above example and accompanying figure is for the lodging step, but the process and figures should not be limited to lodging. This example and process can apply to other data input sections and steps that shard a similar format to the above example. The addition of attractions 755 and tours 765 not in the TrekTracks database to the trek's itinerary can look similar to and follow the above example.

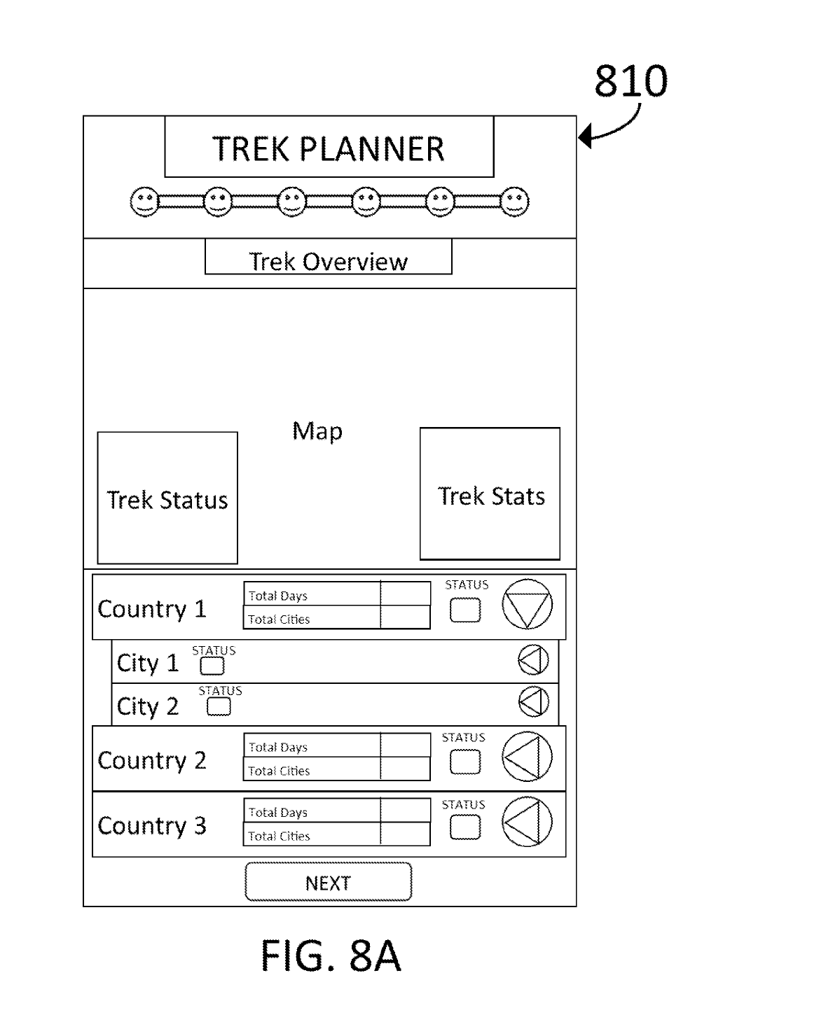

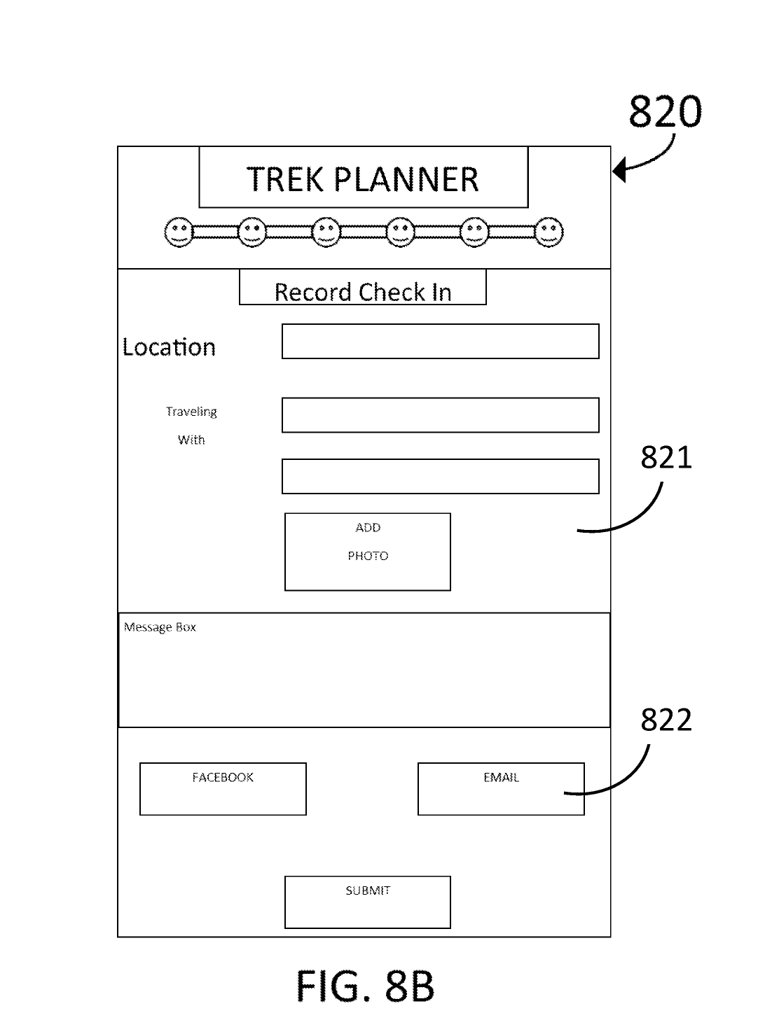

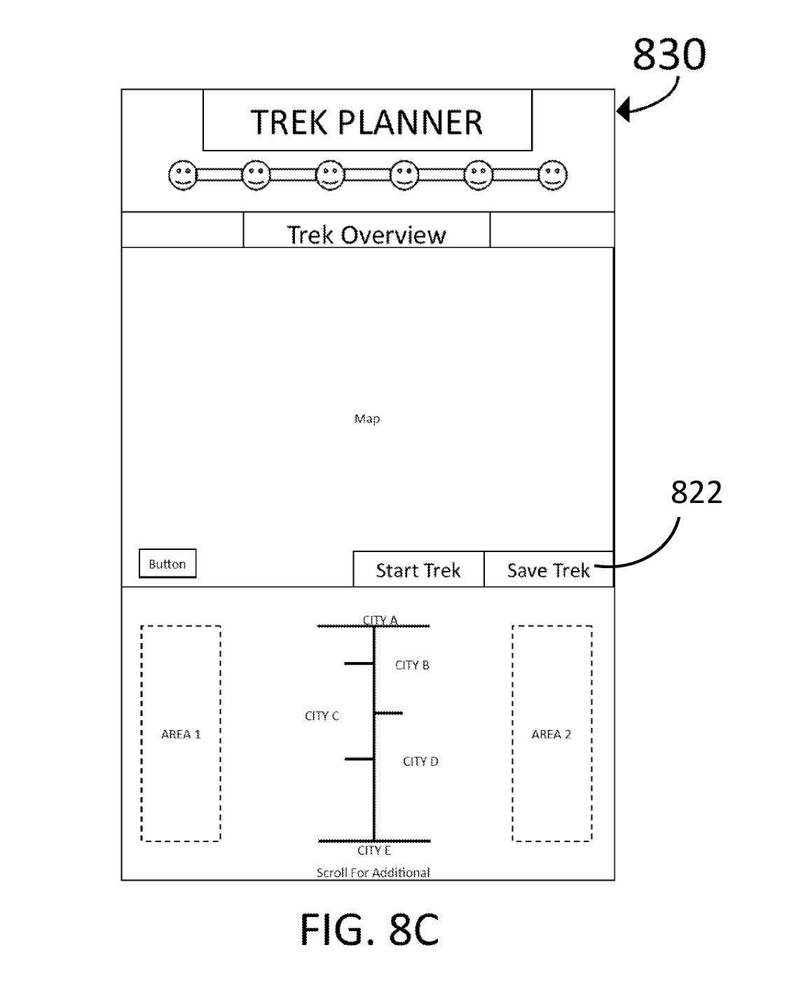

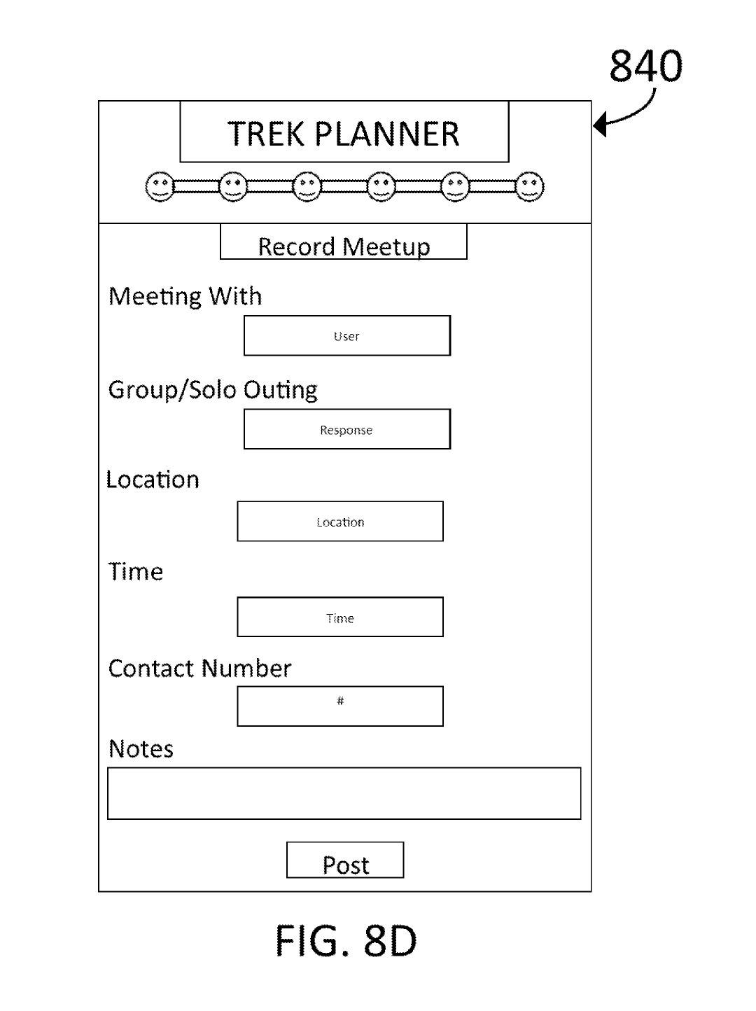

A verification step FIG. 8A can be shown after the completion of the data input for lodging, attractions and tours. This view can display a detailed list of the information entered in Steps 4A-4C and offers an overview specific to the users' individual trek (which is not the same as the “Trek Overview” described in FIG. 8C). This view can display a map and trek stats, similar to those displayed on the dashboard FIG. 4 of the TrekTracks platform.

FIG. 8B depicts a check-in safety feature 820 that users may reach through the screen described in FIG. 8A. The check-in safety feature allows a user to notify friends or family that they have arrived in a location. A user may enter information in section 821 such as a location, who they are traveling with, when they expect to leave, upload a picture, and leave a personal message. The user may they choose how to share the information in section 822, which may include any number of social media web sites such as Facebook or Twitter, and an option to send the notification as a plain email.

FIG. 8C depicts a “Trek Overview” screen that is specific to an individual “Trek” that a user may find in the pre-planned or crowd sourced trek catalogue. This is may include details regarding a route, recommended hotels and attractions, and other information that applies to all users. Button console 822 allows a user to either save the trek to their own trek catalogue 501 as seen in FIG. 5A, or “begin” the trek which will redirect the user to the step depicted in FIG. 6, with many fields predefined.

FIG. 8D depicts a meet-up recorder safety feature 840 that users may reach through the screen described in FIG. 8A. The meet-up recorder safety feature allows a user to notify friends or family that they are with specific people or groups of people. Information recorded may include the names of group members, intended destinations, length of time the user expects the meeting to last, and contact information. The user may choose to share this information via social media or email, or keep it as a private record.

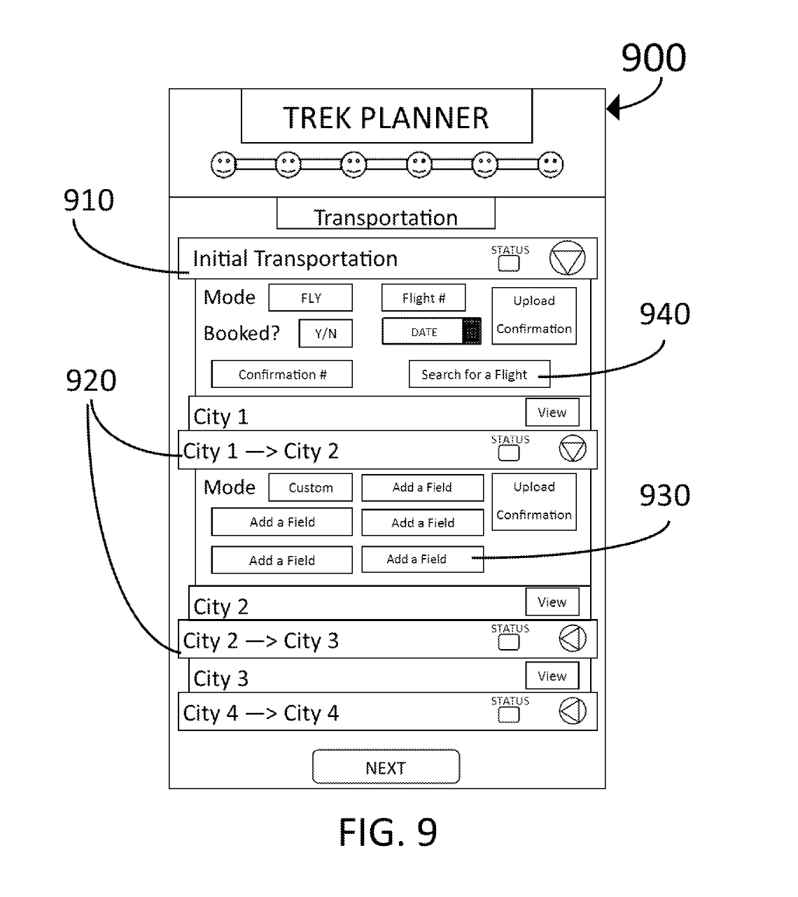

Step 5 FIG. 9 of the TrekPlanner can include sections and information regarding modes of transportation to the starting point of the trip, between waypoints. Step 5 can include a section 910 for information regarding the primary mode of transportation (transportation to the starting destination of the trek). Step 5 can also include a section 920 for information regarding the transportation between waypoints. Step 5 can include the ability to enter multiple modes of transportation 930 for each leg of the trek. Step 5 can include a link 940 to a partnering site used for booking transportation. The sections for information can be provided by the user (manual input) or can be provided by the TrekTracks platform.

If the trek is pre-purchased or taken from the crowd-sourced catalogue, the transportation information between each destination (including primary transportation to the starting destination of the trek) can be prepopulated by the TrekTracks platform, taking into consideration the original trek preferences and any alterations the user has made to the preplanned trek in the previously mentioned data input steps. The user can change one or more of the suggested methods of transportation and the TrekTracks platform can respond by providing other transportation suggestions to stay within the preferences set by the user.

The TrekTracks platform can use the information gathered in Step 5 to display related travel information and updates in other parts of the TrekTracks platform.

Another verification section can show a summary of the data entered in the steps described above. The data displayed can include, but is not limited to, estimated cost and a status indicator to show if the transportation, lodging, attraction(s) and tour(s) have been booked.

Because the TrekPlanner is a data intensive step in planning and preparing for a trip, it can be assumed that many users would complete this step on a computer or other electronic device that allows for easy manipulation of peripheral devices (mouse, keyboard). It should follow that for a user to “select” an option would be to click on the particular option. It should be noted that the TrekPlanner portion of this application can be completed and edited on any type of electronic device as outlined in [0016].

### IV. TrekTracks Social Platform

There can be a section of the TrekTracks platform called “Connect.” The Connect section of the TrekTracks platform can be used to interact and connect with other TrekTracks users. The Connect section can include the ability to connect with another user for the purpose of joining together for part or all of each other's treks. In this type of group travel, each user can be considered a “TravelBuddy.” The connect section can also include the ability for users to set up and include other users in ridesharing between destinations.

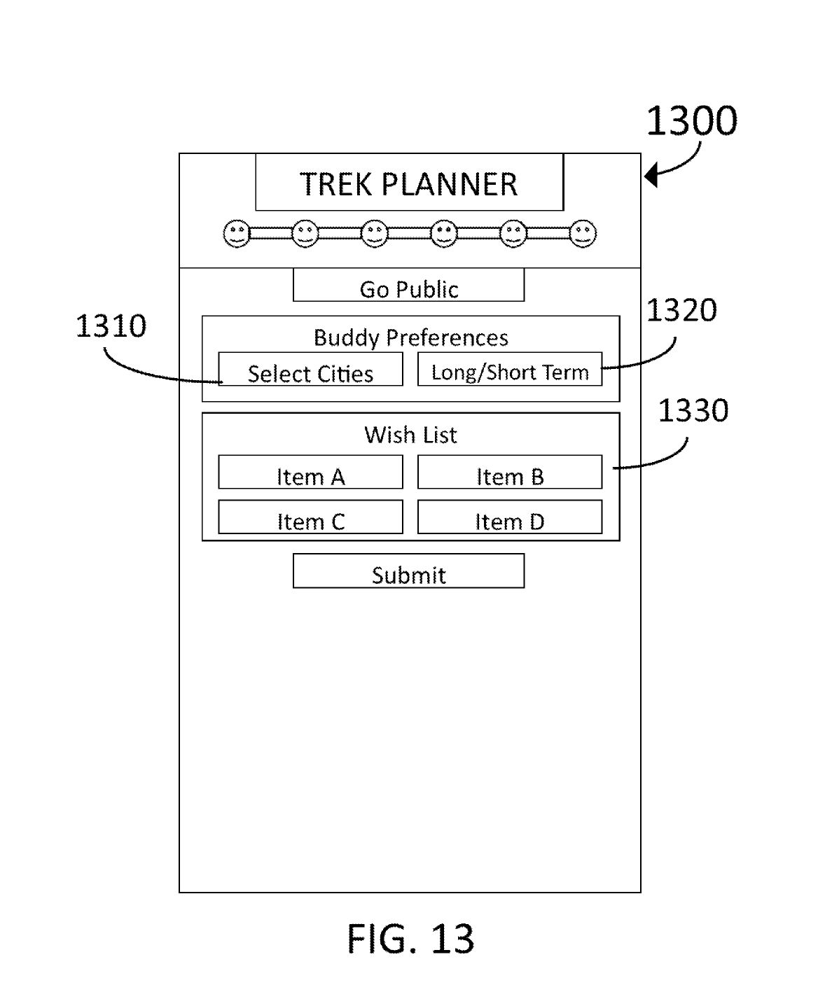

The Connect section of the TrekTracks platform can include a section FIG. 13 to request a TravelBuddy. The user requesting a TravelBuddy can provide the cities 1310 in the user's itinerary that the user wants a TravelBuddy for, the duration of travel 1320 with the TravelBuddy as well as a “wishlist” 1340. This wish list can include, but is not limited to, information regarding attractions the user desires to experience in cities on the user's itinerary. This wish list can be used by the TrekTracks platform and by other users to judge the compatibility of two possible TravelBuddies.

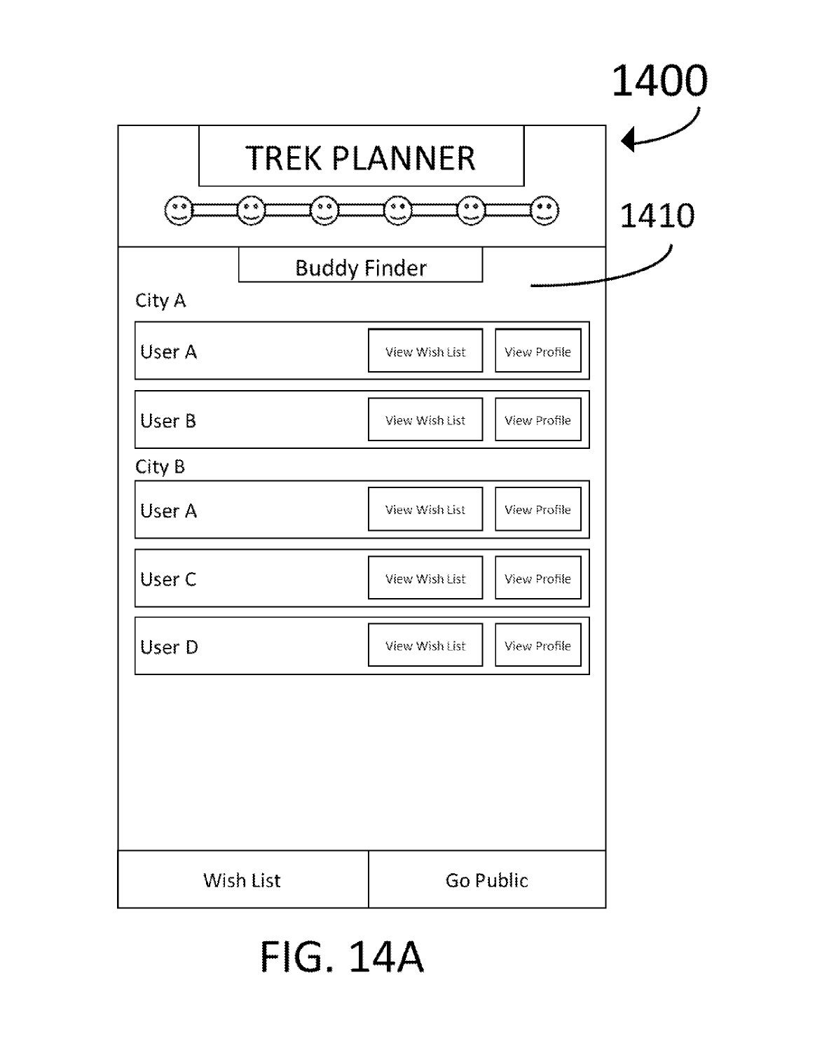

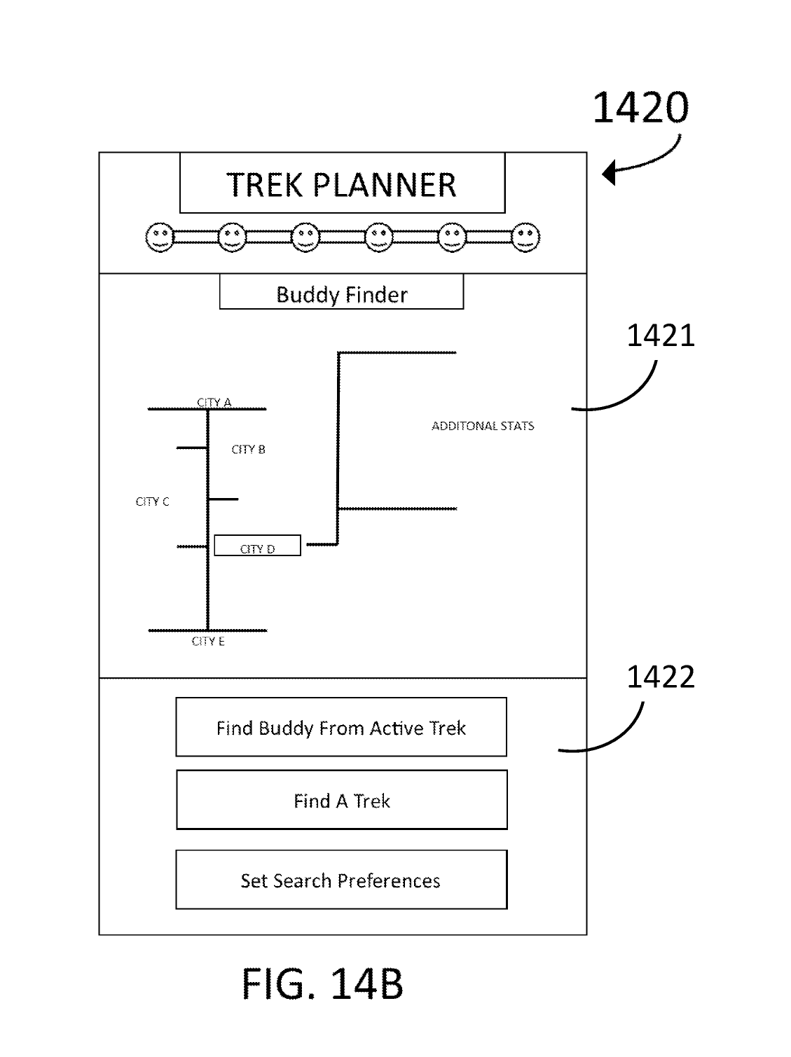

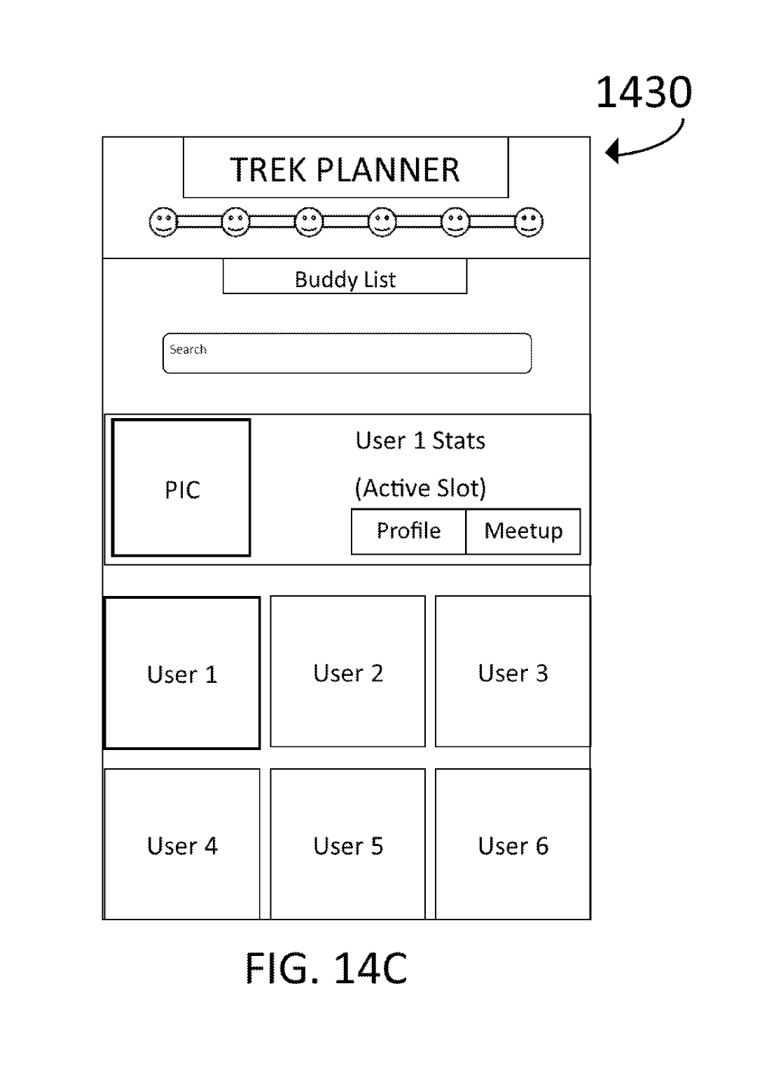

The TrekTracks platform can use the information entered in the TravelBuddy request section FIG. 13 to provide TravelBuddy suggestions FIG. 14A based on full 1410 and partial itinerary matches. The user may also search by city, from the configuration shown in FIG. 14B. Section 1421 provides a visual platform for the user to search by city, while button console 1422 allows a user to search from their active trek, find a trek to activate, or set search preferences. For both match types (partial and full itinerary), the TrekTracks platform can display the matched user's wishlist, link to the matched user's profile and a link to the matched user's contact information. For a partial itinerary matched user, in addition to the previously mentioned information, the TrekTracks platform can display the matched user's match percentage and itinerary. This information can be used by the requesting user to select a TravelBuddy from the other TrekTracks user's suggested by the TrekTracks platform.

Full itinerary matched users share the same city destinations on the same dates as the requesting user. The full match refers to only the portion of the itinerary selected for TravelBuddy dates, not necessary the entire itinerary of each user.

Partial itinerary matched users share some of the same city destinations on some of the same dates. The percentage of coinciding cities and dates is shown relative to the total time selected for the TravelBuddy request dates; this percentage is the “match percent.”

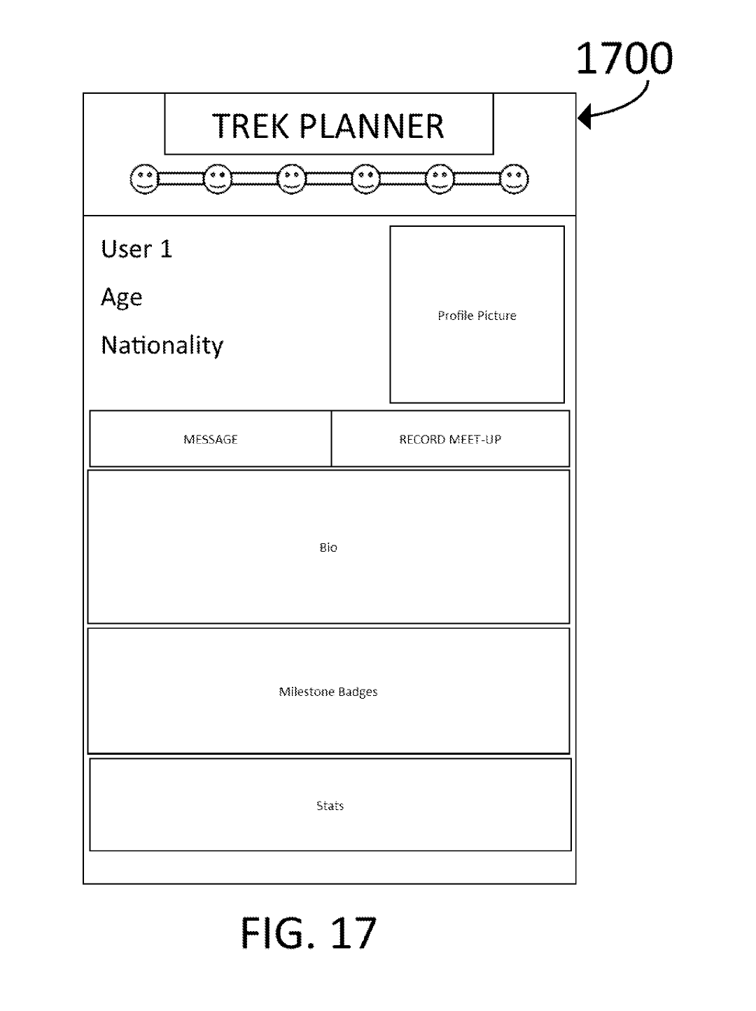

FIG. 14C depicts a potential configuration of a users' travel buddy friend list. Users that have arranged meet ups or contacted each other may appear on the other users list, along with a link to the individuals more detailed profile seen in FIG. 17.

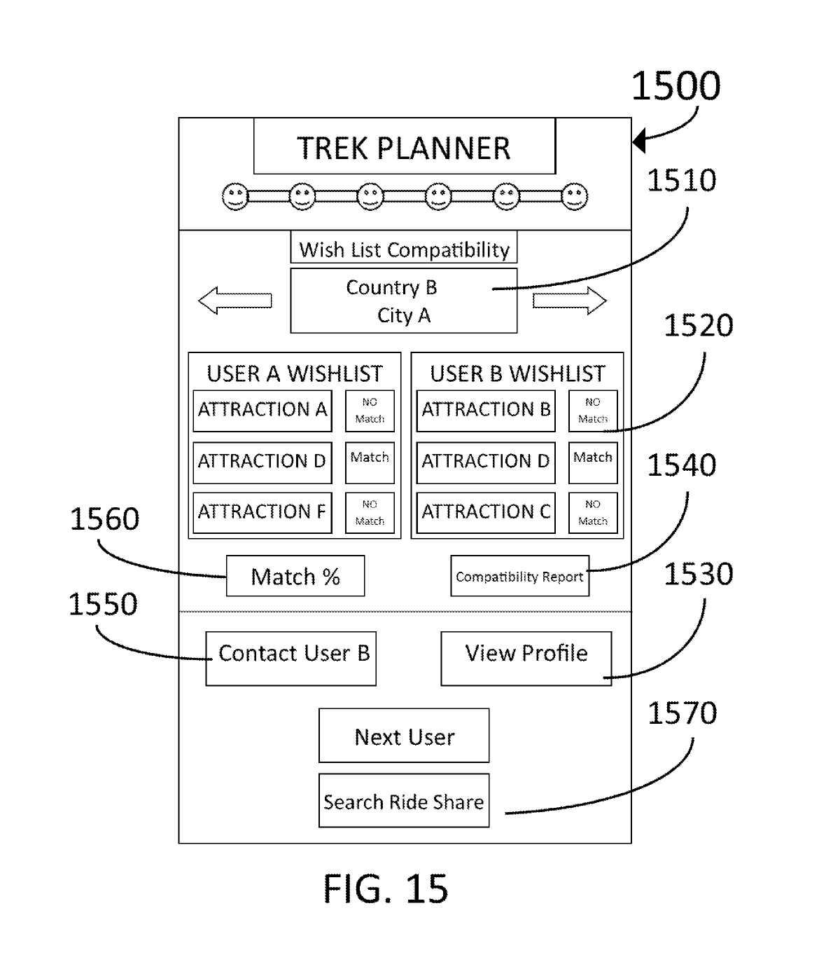

If the requesting user selects to view the wishlist of a matched user, the requesting user can be shown a list of both users wish list FIG. 15. The wish list can be displayed by country and city 1510, allowing the wishlists for each city to be compared 1520. The wish list comparison can indicate if the wishlist item (the attraction originally chosen) is a match with any of the matched user's wishlist items. A link 1530 to the matched users' profile (FIG. 17) can be displayed. A compatibility report of the matched users 1540 can be displayed. The contact information for the matched user 1550 can be displayed. The match percentage 1560 can be displayed. The requesting user can be presented with a link to search rideshares 1570.

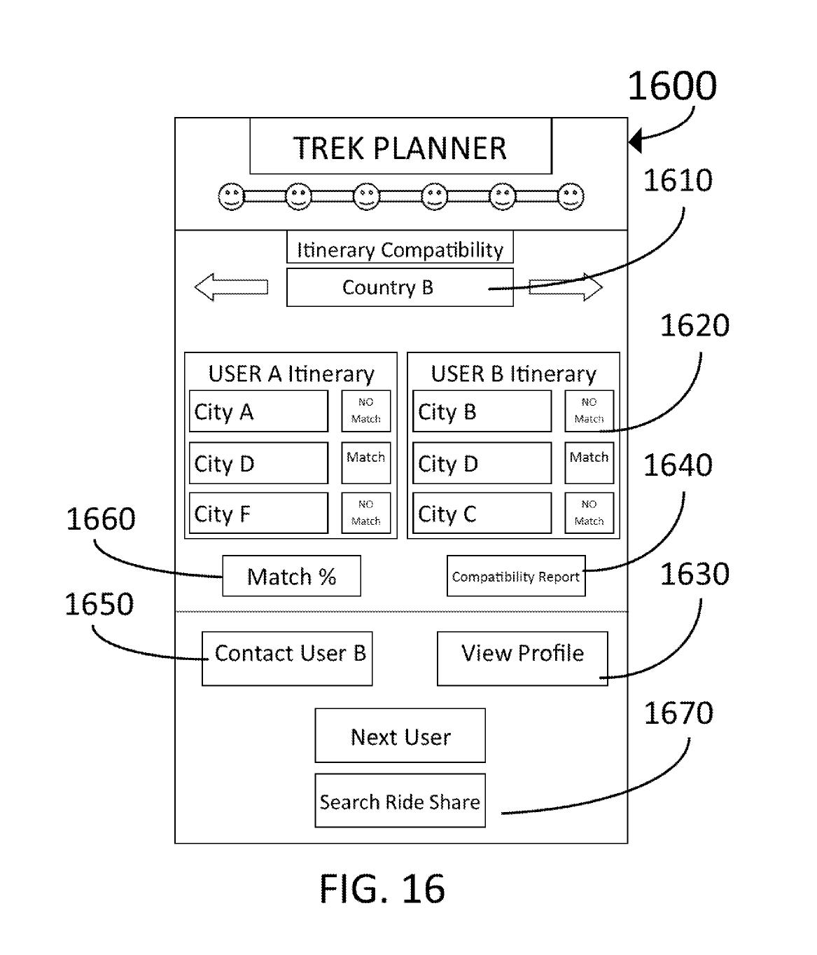

If the requesting user selects to view the itinerary of a matched user, the requesting user can be shown a list of both users' itineraries FIG. 16. The itineraries can be displayed by country 1610, allowing the itineraries of cities for each country to be compared 1620. The itinerary comparison can indicate if the itinerary item (the destination city) is a match with any of the matched user's itinerary items. A link to the matched user's profile 1630 can be displayed. A compatibility report of the matched users 1640 can be displayed. The contact information for the matched user 1650 can be displayed. The match percentage 1660 can be displayed. The requesting user can be presented with a link to search rideshares 1670.

If the requesting user selects to view a matched user's profile FIG. 17, the requesting user can be shown information related to the matched user. The displayed information can include, but is not limited to, name, age, gender and hometown. The matched user's profile can also include, but is not limited to, the number of continents, countries and treks the user has accumulated through TrekTracks services. The matched user's profile can include, but is not limited to, links to the user's Facebook profile, contact information, current and past itineraries in the TrekTracks platform and a photo gallery.

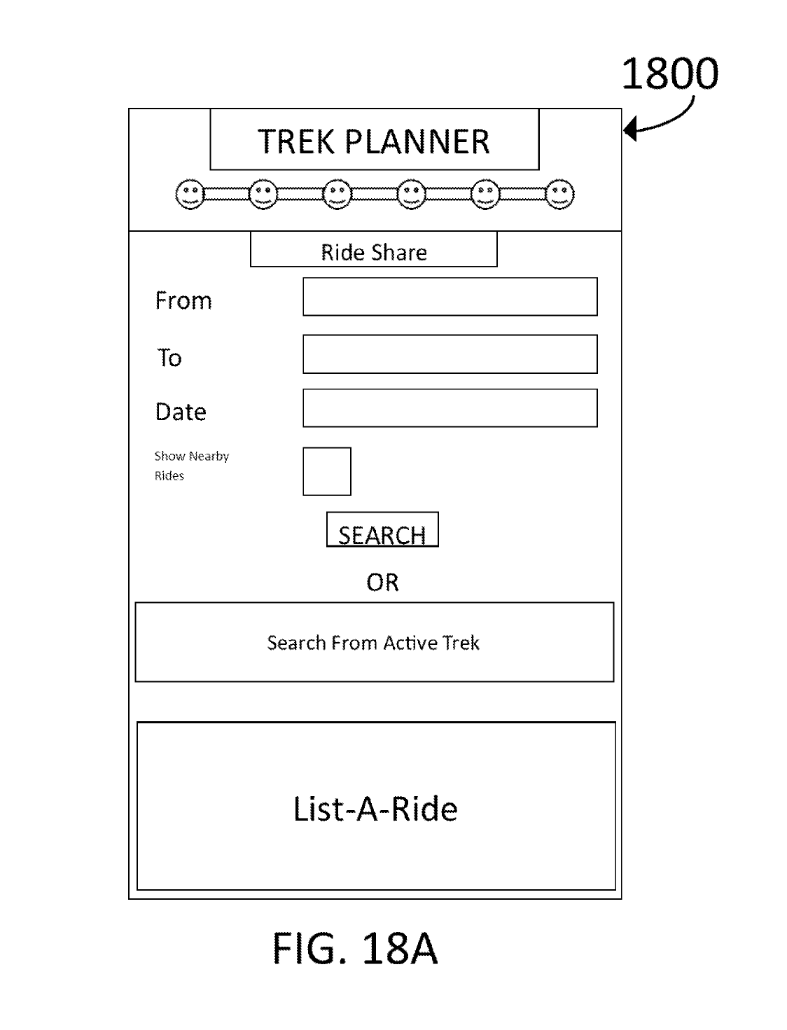

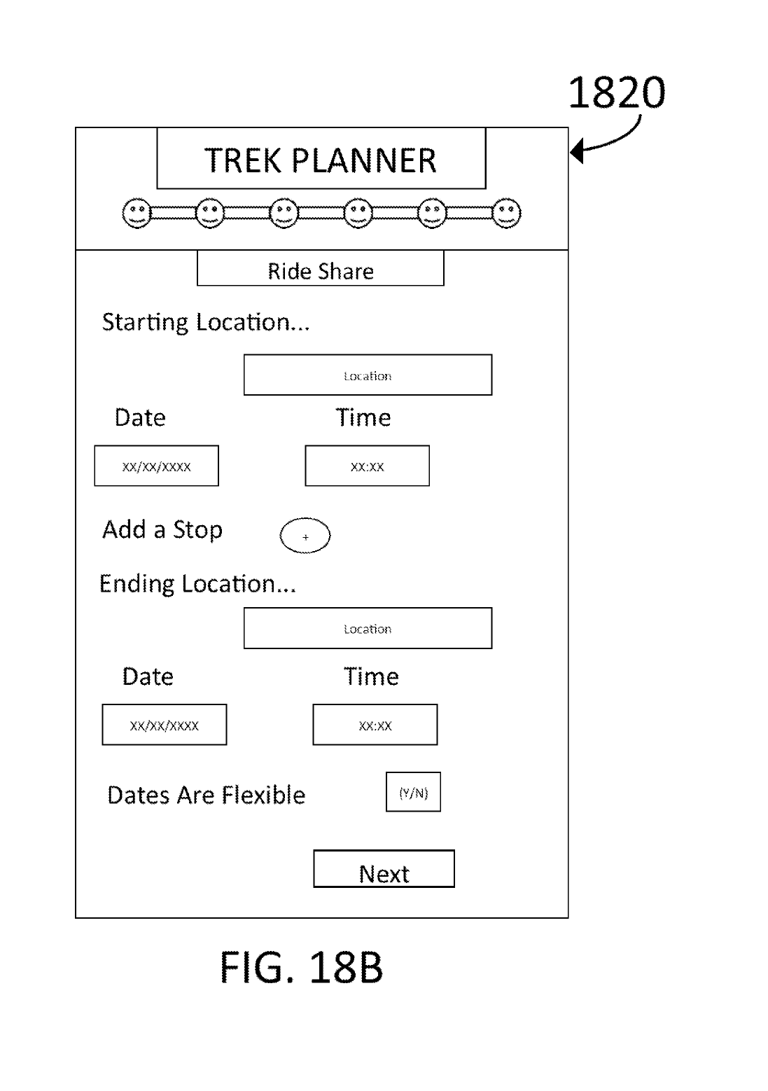

The social aspect of the TrekTracks platform can include the ability to setup and/or join a ridesharing group. This is a group (more than one single user) that can share transportation and transportation costs. The user can be presented with a Connect screen FIG. 18A, which can allow the user to set up a rideshare opportunity. The TrekTracks platform can then offer this rideshare as a rideshare opportunity to other TrekTracks users.

FIG. 18B depicts a possible configuration for the data input step that a user must take to post a rideshare. Among the information collected may be starting location, stops along the way, ending location, and other details about the ride.

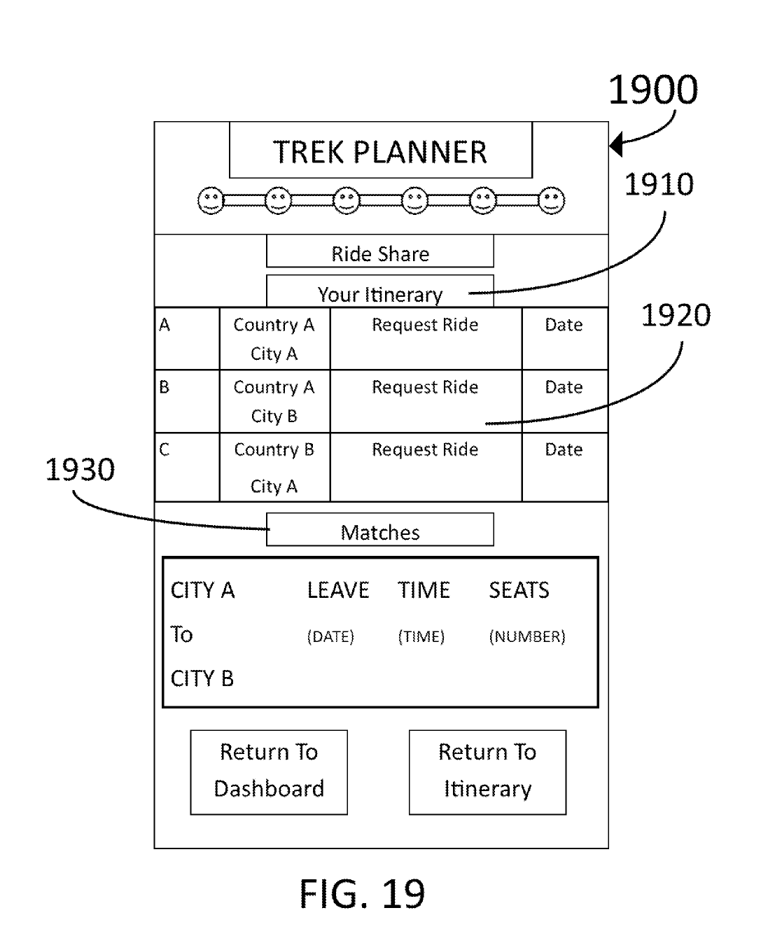

If a user enters the ridesharing section of the TrekTracks platform, information about the user's transportation and transportation dates can be displayed FIG. 19. The information displayed can include, but is not limited to, the user's travel itinerary 1910, a button 1920 requesting a ride between two destination cities, and a list of possible matched 1930 users for ridesharing. The requesting user can also be presented with links to matched users' profile and contact information. These matched users can be matched by the TrekTracks platform on the criteria of same starting and ending destination cities, and travel being on the same day.

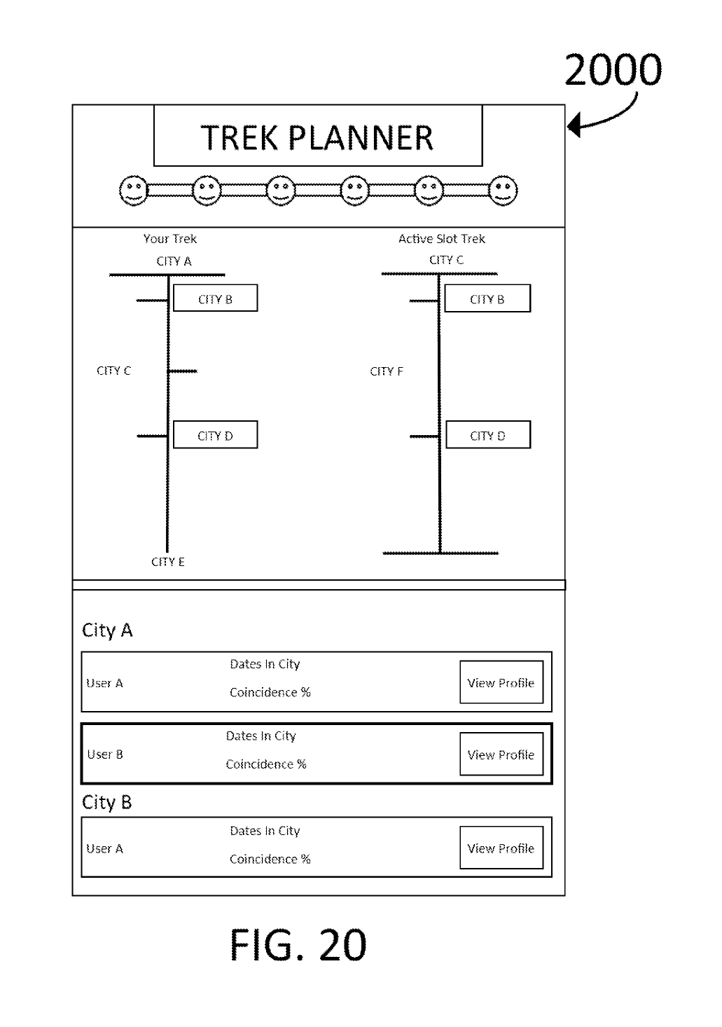

The user can be presented with a Connect summary FIG. 20. This can display a summary of possible ridesharing and TravelBuddy users.

The Connection section of the TrekTracks platform can also allow a user to share trip information and/or tracking information with friends, family and acquaintances. The TrekTracks user can be able to specify certain people that will receive updates or notifications and other information regarding the user's trek and/or the user's progress as the user completes the trek.

### V. Payment and Loyalty Programs

The TrekTracks platform can accept payment for the trips planned using the TrekTracks platform. There can be a payment section of the platform, which can let a user enter a payment method, including, but not limited to, cash, major credit and debit cards, third party accounts (e.g. Paypal), virtual currencies (e.g. Bit-Coin) and/or other methods of accepted payment.

Additionally, the TrekTracks platform can include a “TrekMiles” feature. These TrekMiles can act like “frequent flyer miles” or “loyalty points.” These TrekMiles can be given and accumulated by a user for using the TrekTracks platform to plan, book, organize and/or track a trek.

TrekMiles can be accumulated by, for example, providing a variety of travel-related goods and/or services, including lodging accommodations, travel supplies, tours, transportation, sporting events and entertainment tickets. TrekMiles may be traded, gifted, shared and/or accepted amongst registered TrekMiles members.

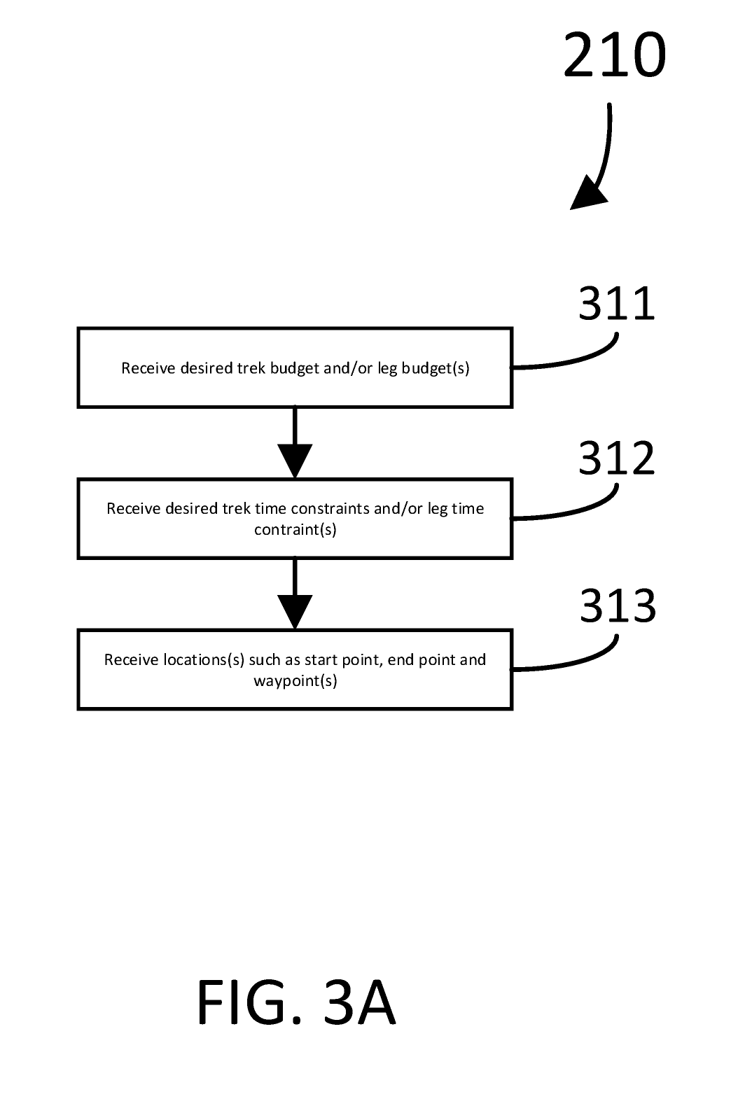

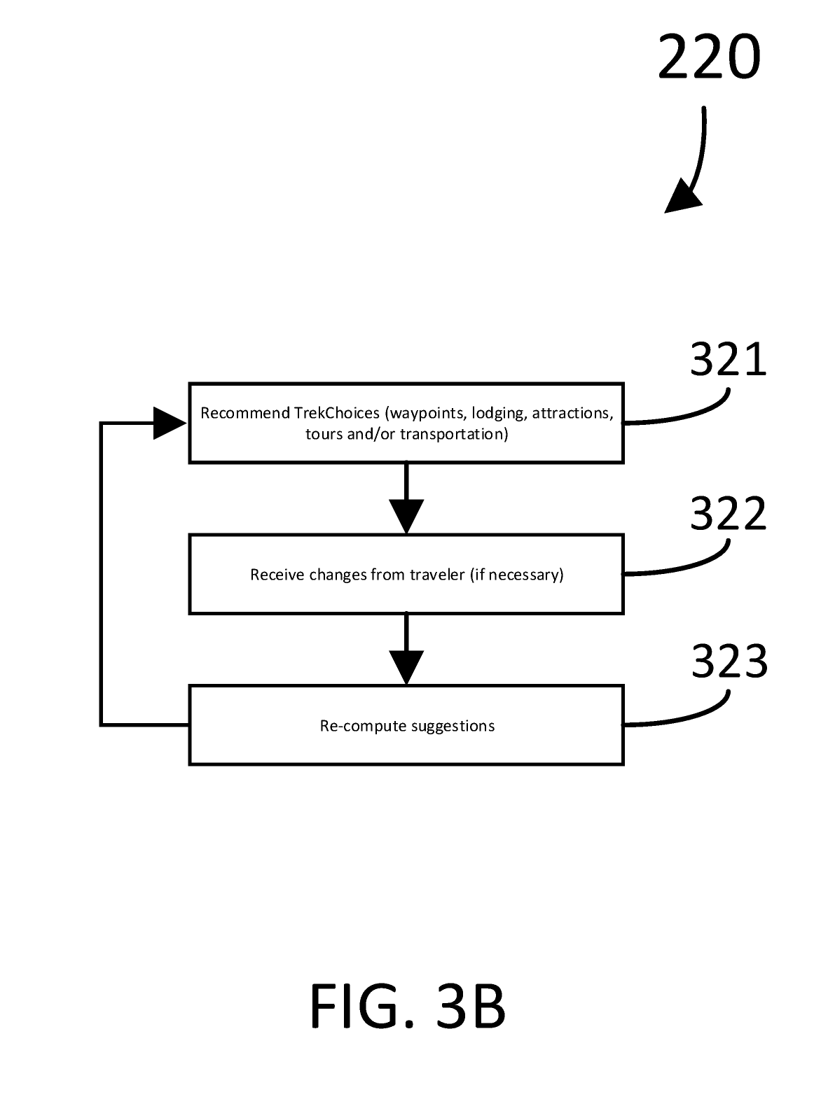

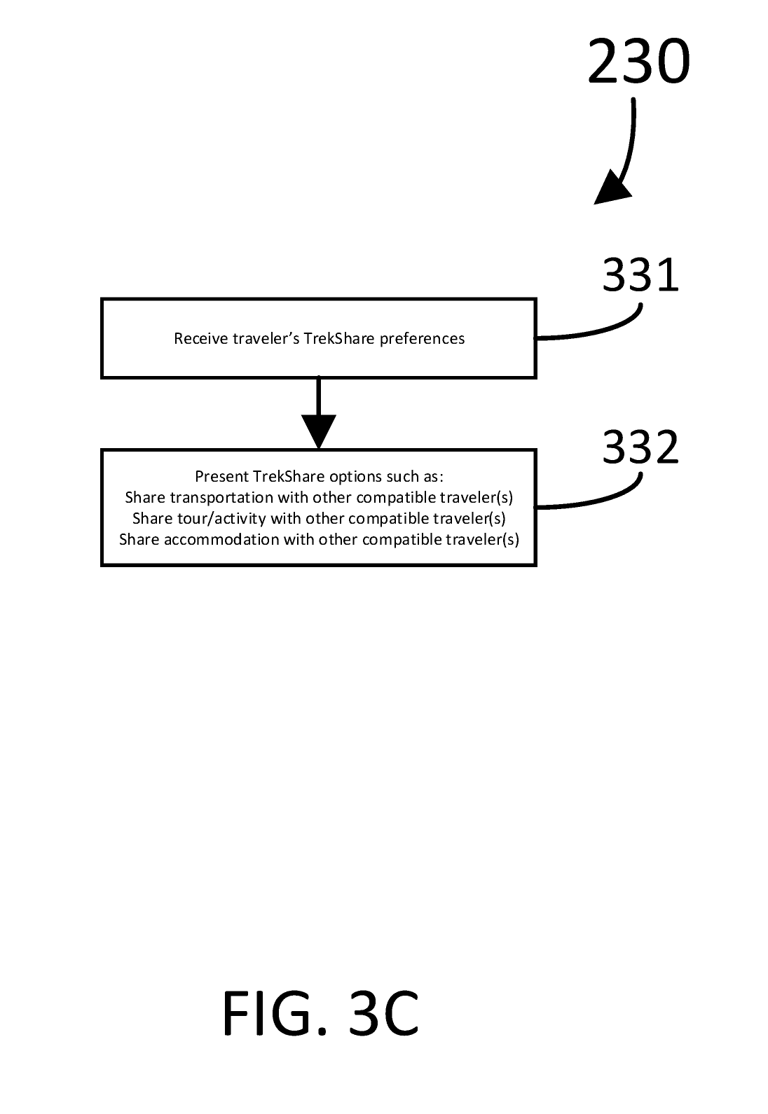

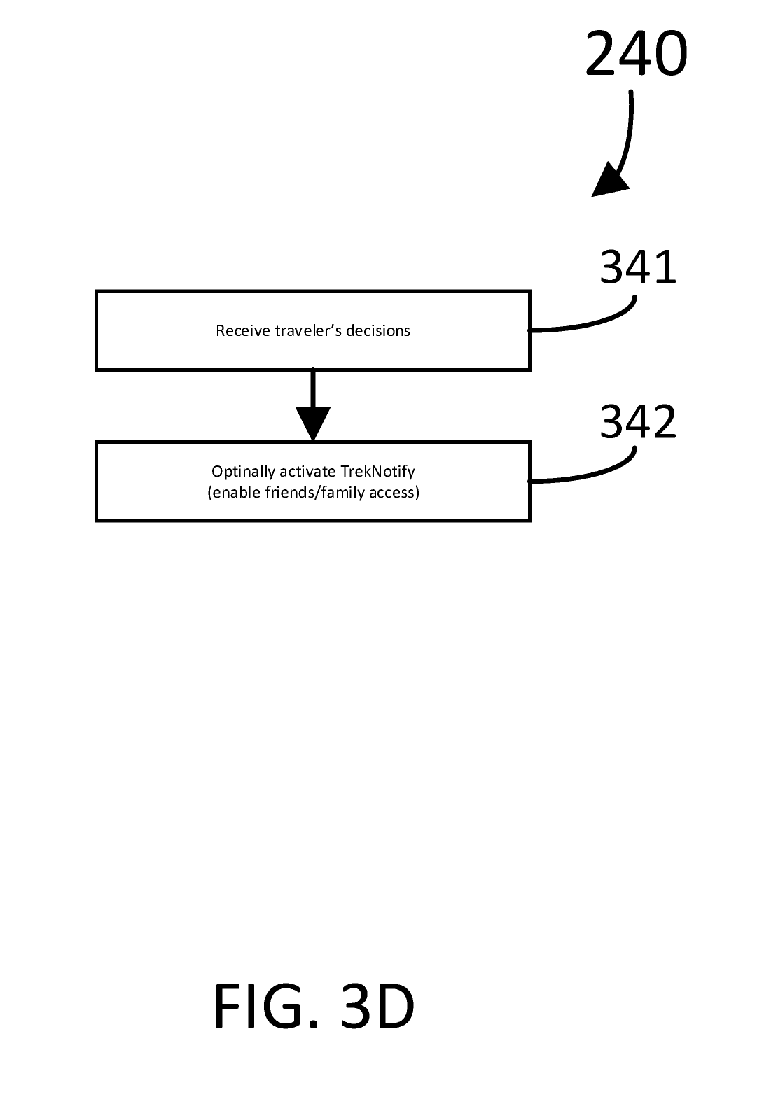

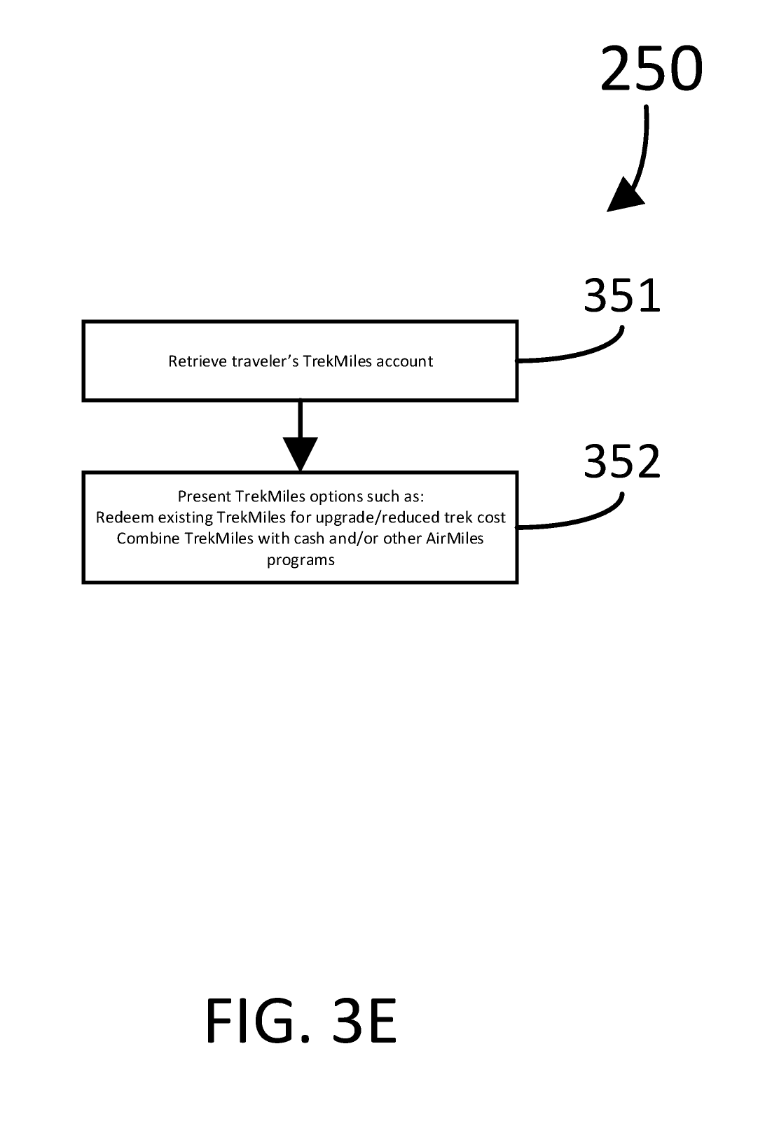

FIG. 3E shows how a user can apply or use TrekMiles to pay for part or all of the cost of a trek. The user's accumulated TrekMiles can be used to upgrade current selections of the trek, including, but not limited to, lodging accommodations, transportation accommodations, tour accommodations or attraction accommodations. If the user does not wish to credit accumulated TrekMiles towards the outstanding balance of the trek, the TrekTracks platform can still receive the user's account information so that additional TrekMiles for the current trek can be credited to the account.

In sum, the present invention provides a system and methods for planning, organizing, booking and tracking a trip. The advantages of such a system include receiving aid and suggestions while planning a trip; booking accommodations, attractions, tours and transportation in one application; organizing trip related information in one application; tracking and sharing information about a trip in one application.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. In a computerized customizable travel planning and tracking system, a method comprising:
receiving a recommendation request for at least one leg of a travel plan from a traveler;
providing at least one choice in response to the recommendation request and in consideration of a profile of the traveler, wherein the at least one choice includes at least one of transportation, food and lodging associated with the at least one leg of the travel plan, and wherein the at least one choice also includes supplemental information regarding the at least one leg of the travel plan; and
incorporating one of the at least one choice chosen by the traveler into the travel plan.

2. The method of claim 1 further comprising providing at least one travel option complementary to the at least one leg of the travel plan.

3. The method of claim 2 wherein the travel option presented to the user is sourced from the data collected from a third party user.

4. The method of claim 1 further comprising providing at least one new travel option complementary to the at least one leg of the travel plan in response to a change in preferences by the traveler.

5. The method of claim 1 further comprising providing a substantially real-time trek progress report with at least one waypoint as the traveler begins each leg of the travel plan.

6. The method of claim 5 wherein the trek progress report is provided to at least one of the travelers and at least one previously authorized recipient.

7. The method of claim 5 wherein a manual check in by a user, in the form of location and other data entry, facilitates a distribution of the data to at least one previously authorized recipient or service.

8. The method of claim 1 further comprising of facilitating matching the traveler with at least one potential travel companion having a substantially similar itinerary for the at least one leg.

9. The method of claim 8 wherein the facilitating includes providing the traveler with a portion of the profile or itinerary of the at least one potential travel companion.

10. The method of claim 8 wherein the matched travelers or groups of travelers facilitate a rideshare based on at least a portion of their itineraries.

11. The method of claim 8 wherein the matched travelers or groups of travelers may facilitate filling group tours, activities, or programs, based on at least a portion of their itineraries.

12. The method of claim 1 further comprising of debiting a barter travel account associated with the traveler upon selecting one of the at least one choice.

13. The method of claim 1 further comprising of crediting a barter travel account associated with a second traveler upon selecting one of the at least one choice.

14. A computerized customizable travel assistant comprising:
a user interface configured to receive a recommendation request for at least one leg of a travel plan from a traveler;
a server configured to generate at least one choice in response to the recommendation request and in consideration of a profile of the traveler, wherein the at least one choice includes at least one of transportation, food and lodging associated with the at least one leg of the travel plan, and wherein the at least one choice also includes supplemental information regarding the at least one leg of the travel plan, and wherein the server is further configured to incorporate one of the at least one choice chosen by the traveler into the travel plan; and
wherein the user interface is further configured to provide the traveler with the at least one choice.

15. The server of claim 14 wherein the server is configured to provide at least one travel option complementary to the at least one leg of the travel plan.

16. The server of claim 14 wherein the server is configured to provide at least one new travel option complementary to the at least one leg of the travel plan in response to a change in preferences received from the traveler.

17. The server of claim 14 wherein the server is configured to provide a substantially real-time progress report with at least one waypoint as the traveler begins each leg of the travel plan.

18. The server of claim 17 wherein the server is configured to provide the progress report to at least one of the travelers and at least one previously authorized recipient.

19. The server of claim 17 wherein the server is configured to allow a manual check in by a user, in the form of location and other data entry, and facilitates the distribution of the data to at least one previously authorized recipient or service.

20. The server of claim 14 wherein the server is configured to facilitate the matching of the traveler with at least one potential travel companion having a substantially similar itinerary for the at least one leg.

21. The server of claim 20 wherein the server is configured to provide the traveler a portion of the profile of the at least one potential travel companion to facilitate the matching.

22. The server of claim 20 wherein the server is configured to facilitate matched travelers or groups of travelers with a rideshare based on at least a portion of their itineraries.

23. The server of claim 20 wherein the server is configured to facilitate matched travelers or groups of travelers with group tours, activities, or programs, based on at least a portion of their itineraries, to enable filling places with at least one other user.

24. The server of claim 14 wherein the server is configured to debit a barter travel account associated with the traveler upon selecting one of the at least one choice.

25. The server of claim 14 wherein the server is configured to credit a barter account associated with a second traveler upon selecting one of the at least one choice.
